(19) United States
(12) Patent Application Publication
(10) Pub. No.: US 2015/0339324 A1
(43) Pub. Date: Nov. 26, 2015

(54) System and Method for Imagery Warehousing and Collaborative Search Processing

(71) Applicants: Mark E. Westmoreland, Flower Mound, TX (US); Walter W. Westmoreland, Flower Mound, TX (US)

(72) Inventors: Mark E. Westmoreland, Flower Mound, TX (US); Walter W. Westmoreland, Flower Mound, TX (US)

(73) Assignee: Road Warriors International, Inc., Flower Mound, TX (US)

(21) Appl. No.: 14/714,258

(22) Filed: May 16, 2015

Related U.S. Application Data
(60) Provisional application No. 62/000,907, filed on May 20, 2014.

(51) Int. Cl. G06F 17/30; G06K 9/00

(52) U.S. Cl. CPC G06F 17/30268; G06F 17/30274; G06K 9/00228; G06F 17/30277

(57) ABSTRACT

Heterogeneous imagery data of all varieties, from any configured sources, is maintained to a data warehouse for expedient access and convenient search processing. Imagery content maintained is processed for deriving associated search schema including multiple types of metadata, cross reference information for conclusively associating metadata, and diagnostics information for associating metadata with potential correlation. Collection processing governs contents of the warehouse, and is fully configurable to adapt to small customized installations as well as meeting scale requirements of a world population. Client processing provides a variety of useful searches, many options for processing imagery objects, and enables clients to contribute to objects collected for enhancing a collaborative social experience for the benefit of all users.

This application claims the benefit of the filing date of the U.S. Provisional Patent Application Ser. No. 62/000,907, filed May 20, 2014, the disclosure of which is hereby incorporated herein by reference in its entirety for all purposes.

### TECHNICAL FIELD

The present disclosure relates generally to data warehousing and intelligent search interfaces, and more particularly to data warehousing of imagery data, searching and processing the imagery data, and enhancing the usability of the imagery data for a wide range of applications.

### BACKGROUND

Different users use different types of Mobile Recording Systems (MRSs) equipped to record data such as photos, videos, and audio. Such MRSs may be referred to as mobile devices including laptops, tablet computers, cell phones, Personal Navigational Devices (PNDs), Android enabled devices, iPhones, iPads, handheld digital cameras, camcorders, and like data processing systems which are capable of recording such information. A Mobile Recording System (MRS) may be equipped with a variety of features for capturing imagery data (e.g. photos and videos). Audio data may also be associated with the imagery data, for example as specified with a photo by a user, or as part of the recorded video. Depending on the particular MRS, a user controls in a variety of ways how the imagery data is recorded. The user may also have a variety of ways how the imagery data is altered, or added to, after it is recorded, including being able to modify appearance, attributes, and other data of, or associated to, the imagery data. Advanced MRSs provide automation for processing imagery data, as well as user interfaces for sharing the imagery data with other users, for example through a commonly accessed service. The imagery data may be uploaded to a service over a wired or wireless connection in order to populate a repository, share with friends, or make available for a variety of purposes. A method and system is needed for anticipating the many applications for processing imagery data from any sources, including MRSs, surveillance installations, libraries of imagery, etc. A comprehensive and collaborative service can be provided for a variety of different applications in a single service implementation.

Popular search engines (e.g. Bing, Google, etc) do a good job of crawling the internet for web pages, building indexes, prioritizing search results, and providing search results to users entering textual search queries. An images or videos option additionally provides search results of imagery data based on a user's query, for example to find images associated with web pages containing certain sought text, file names, or file types. The advanced crawler engines include the imagery data for providing imagery specific search results from the internet. However, there are many different methods of search which are not provided, and there is little available for users to collaborate so that imagery data becomes richer with associated metadata information. The present disclosure presents a system and method for accomplishing different imagery data search techniques and collaborative processing unavailable in known systems.

### SUMMARY

Heterogeneous imagery data of all varieties, from any configured sources, is maintained to a data warehouse for expedient access and convenient search processing. Imagery data, imagery content, and imagery object(s) are terminologies used interchangeably to refer to image or video content and having associated metadata information. Imagery content maintained is processed for deriving associated search schema including multiple types of metadata, cross reference information for conclusively associating metadata, and diagnostics information for associating metadata with potential correlation. Metadata directly attached with the imagery objects is used. Some metadata may be determined automatically, or provided to a user for reconciliation, or created for subsequent use as directed by a user. Cross reference information provides conclusive correlation of new metadata to an imagery object and diagnostics information provides inconclusive correlations of new metadata to an imagery object, for example as assigned through user interfaces exploiting use of the imagery objects. The present disclosure leverages experience/expertise of some users in processing metadata to benefit all users, and many search interfaces are supported for imagery data across many applications.

In one preferred embodiment, the system and method disclosed herein is provided as an on-demand cloud based Software-As-A-Service (SaaS) having user interfaces which also store data in the cloud. A particular application of the present disclosure need not have a single entity of owned hardware infrastructure, data storage infrastructure, or any other overhead hardware footprint except at least one client data processing system having any of a variety of internet browsers. Similarly, a third party operator of the present disclosure also need not own any infrastructure or footprint. Of course, any client device is capable of using the SaaS, for example, a personal computer, notebook computer, iPad, iPhone, Android based device, wireless phone or smartphone, tablet computer, MRS, or any other data processing system. All devices with an internet browser are supported. In another embodiment, a third party operator of the present disclosure chooses to physically manage their owned footprint and infrastructure instead of housing functionality at a cloud provider. In yet another embodiment, conventional client/server architecture is implemented in native application form for eliminating the requirement to have an internet browser. In such an embodiment, a client side application may be preinstalled, or downloaded and installed in a convenient manner. A primary advantage herein is to provide SaaS (or other embodiment as described above) functionality for efficiently carrying out common business enterprise practices and processes with respect to imagery processing. It is a further advantage to provide such functionality to a plurality of business enterprises in a single instance deployment.

Collection processing governs contents of the warehouse, and is fully configurable to adapt to small customized installations as well as meeting scale requirements of a world population. Collection run-time processing is extendible with run time plug-in processing for maintaining leadership in proprietary imagery data processing without requiring new build versions of the present disclosure as new hardware and software solutions are made available for processing imagery data and identifying new types or uses of metadata. Client processing provides a variety of useful searches and enables clients to contribute to objects collected for enhancing a collaborative social experience. For example, imagery data can be analyzed, and a user's expertise involved for accepting automatically determined metadata, or user assigned metadata, to be associated with the imagery data for the benefit of other users. Client run-time processing is also extendible with run time plug-in processing for maintaining leadership in proprietary imagery data processing without requiring new build versions of the present disclosure.

Another advantage of the present disclosure is a collaborative social interaction between users. Imagery processing efforts by one user can be used to improve efforts by another user in client processing. For example, queries formed, metadata analyzed, and correlation information determined can be observed by a user, manipulated by a user, or maintained by a user, for new configurations, queries, actions, and metadata processing performed by other users.

Another advantage is an approval process for making alterations to imagery collection warehouse data. An approval hierarchy of administrated users is imposed for approving and enabling configurations by different users. Trusted users can perform any alterations. Untrusted users require at least authentication, and some require their operations/actions be approved before becoming active or enabled. User data can be entered by graphical user interface, wizard-based menus, bulk loading by script, and administrated plug-in processing.

It is an advantage to notify/alert one or more users when a queued query is performed. Users need not poll imagery collection warehouse data with queries. Users can configure pending queries which trigger upon the sought data becoming available from future collection(s). It is another advantage to support configurations for how the notifications are delivered and what should be delivered in the notifications, when using queued queries. The queued query is configured with alert notification criteria by email or SMS messaging.

It is another advantage in providing a comprehensive imagery search capability through supporting any queries having terms, operators, and expressions for finding information, wherein the terms are used to match to data of the imagery data. Parenthesis may be used for forming complex conditions. Every individual metadata instance is an object for a query term. File types, automatically recognized objects found within the imagery (e.g. faces, buildings, objects, etc), and any useful data of, determined for, or user assigned to, the imagery becomes a metadata object for a query term. Database schema (e.g. table name, column names, matching data therein) is reasonably referenced by terms for rich querying. The capabilities of a particular MRS are exploited from the standpoint of providing rich search functionality, for example supporting complex queries for unusual metadata.

It is another advantage in providing convenient selectable query objects in outbound email or SMS messages for communicating a particular query. A query object consists of a small graphic and an associated URL query. A client processing system user can embed the small graphic as HTML with an underlying URL link to a web service page for returning results of a query, or for performing complex processing to produce desired results. For example: ‘<a href=“https://www.icwh.com/srv_page?p1=12&p2=alpha”><img src=“images/emoji.jpg”/></a>’ produces a small emoji.jpg with link that can be clicked by a recipient for performing a query or other service processing.

It is a further advantage in extending conventional metadata with many new varieties of metadata. Metadata is broadly used in the present disclosure for including any data that can be associated to an imagery object, whether it was originally attached as metadata, maintained by imagery processing for new metadata, or maintained by user processing for new metadata. New metadata is determined, and defined as any data which can be associated to an imagery object, regardless of how the associated data was determined. Different categories and types of metadata are provided.

A further advantage is maintaining of statistical and log data for why, how, when, and where collection and client related processing takes place, and who is involved with that related processing. In fact, rigorous tracking of collection processing and user interface processing is used for providing full audit capability, for example in law enforcement applications. This provides means for reporting, un-doing client user actions, and auditing historical activity.

Another advantage is providing metadata association intelligence at pre-load to the imagery collection warehouse, at post-load of the imagery collection warehouse, and at times of user access to the imagery collection warehouse. Collection processing (i.e. pre-load) can analyze imagery for populating the warehouse with useful data describing the particular imagery data, or for transforming an imagery object. This enhances usability of the data. Client processing (i.e. post-load) can analyze or transform imagery upon access of the data from the warehouse. This also enhances usability of the data after it has already been collected into the warehouse. Background AGents (BAGs) can also be configured for grooming, archiving, or transforming the imagery data.

Yet another advantage is providing a pluggable platform for proprietary algorithms to perform pre-load and post-load processing that may not already be encoded in the imagery platform itself. Proprietary and third-party plug-in executables are easily adapted to the present disclosure processing. Facial recognition processing, imagery object recognition processing, geofence processing, geocoding translation processing, imagery transformation processing, and artificial intelligence processing is incorporated in all key processing paths using the best techniques as they become available. The present disclosure system and method does not have to be recompiled, relinked, and rebuilt. Third party plug-in processing is simply adapted as is, provided it conforms to a standard run time interface.

Further features and advantages of the disclosure, as well as the structure and operation of various embodiments of the disclosure, are described in detail below with reference to the accompanying drawings. In the drawings, like reference numbers generally indicate identical, functionally similar, and/or structurally similar elements. None of the drawings, discussions, or materials herein is to be interpreted as limiting to a particular embodiment. The broadest interpretation is intended. Other embodiments accomplishing same functionality are within the spirit and scope of this disclosure. It should be understood that information is presented by example and many embodiments exist without departing from the spirit and scope of this disclosure.

### DESCRIPTION OF DRAWINGS

There is no guarantee descriptions in this specification explain every novel feature found in the drawings. The present disclosure will be described with reference to the accompanying drawings, wherein:

FIG. 1 depicts an architectural diagram facilitating a high level discussion of the present disclosure;

FIG. 2 depicts an architectural diagram describing a preferred embodiment of imagery collection processing;

FIG. 3 depicts an architectural diagram describing a preferred embodiment of client processing;

FIG. 4 depicts a block diagram of a data processing system useful for implementing a MRS, a service, a collector, a manager, or any other data processing system carrying out disclosed processing or functionality;

FIG. 5A depicts an illustration for describing a preferred embodiment of data maintained to the Imagery Collection Warehouse (ICW);

FIG. 5B depicts an illustration for describing a preferred embodiment of data maintained to client data;

FIG. 5C depicts an illustration for describing joined schema to discuss details of certain data of the present disclosure;

FIG. 6 depicts a flowchart for describing a preferred embodiment of collector thread processing;

FIGS. 7A through 7E depict flowcharts for describing a preferred embodiment of Warehouse Client Service (WCS) processing; and

FIG. 8 depicts an illustration for describing parameters passed to a preferred embodiment of plug-in processing.

### DETAILED DESCRIPTION

With reference now to detail of the drawings, the present disclosure is described. Obvious error handling is omitted from the flowcharts in order to focus on key aspects. A thread synchronization scheme (e.g. semaphore use) is assumed where appropriate. A semicolon may be used in flowchart blocks to represent, and separate, multiple blocks of processing within a single physical block for simpler flowcharts with fewer blocks in the drawings by placing multiple blocks of processing description in a single physical block of the flowchart. Flowchart processing is intended to be interpreted in the broadest sense by example, and not for limiting methods of accomplishing the same functionality. Disclosed user interface processing is preferred embodiment examples that can be implemented in various ways without departing from the spirit and scope of this disclosure. Alternative user interfaces (since this disclosure is not to be limiting) will use similar mechanisms, but may use different mechanisms without departing from the spirit and scope of this disclosure. Novel features disclosed herein need not be provided as all or none. Certain features may be isolated in some embodiments, or may appear as any subset of features and functionality in other embodiments.

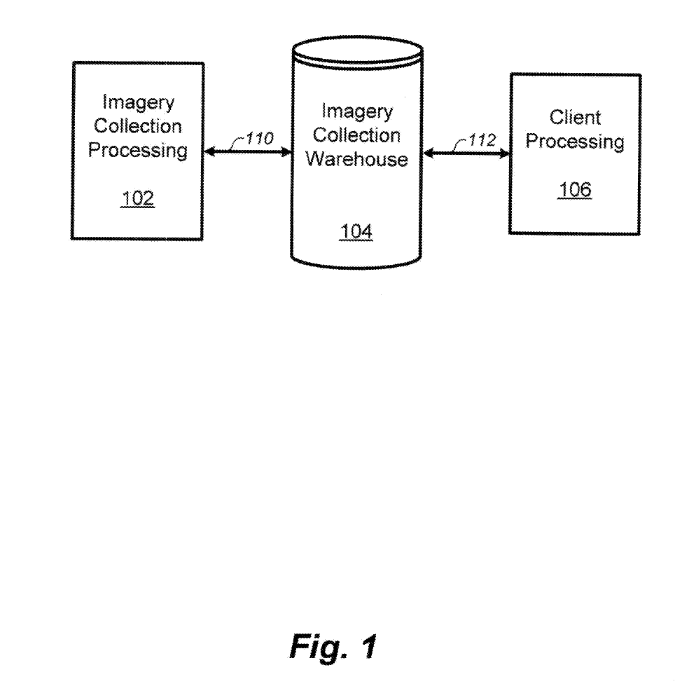

FIG. 1 depicts an architectural diagram facilitating a high level discussion of the present disclosure. Imagery collection processing 102 collects imagery data with or without existing metadata associated thereof, and processes it for storing in an appropriate manner to Imagery Collection Warehouse (ICW) 104. ICW 104 is preferably a Standard Query Language (SQL) database having a plurality of tables and other schema with appropriate indexes and constraints in support of SQL interfaces for accessing and managing data therein. ICW 104 may be a standalone database, a parallel database configuration or any of a variety of high performance configurations, a database spread across multiple systems and/or storage area networks and/or storage devices, a database spread out over vast geographical distances and/or data centers, multiple databases, etc. Data other than SQL form may also be used, or combinations thereof, for example Hadoop format, a set of files, NFS data, NTFS data, FAT data, or other data forms without departing from the spirit of this disclosure. Other databases described herein are similarly defined in many embodiments just as defined for the ICW 104 (i.e. databases 204, 216, 282, 284, 286, 288, 290, 306, etc), and databases disclosed may share a common platform, installation, or same database instance.

Databases and data described herein (e.g. any of FIGS. 1 through 8) may be multi-part fields (i.e. have sub-fields), fixed length records, varying length records, or a combination with field(s) in one form or the other. Some data embodiments will use anticipated fixed length record positions for subfields that can contain useful data, or a null value (e.g. −1). Other data embodiments may use varying length fields depending on the number of sub-fields to be populated. Other data embodiments will use varying length fields and/or sub-fields which have tags indicating their presence. Other data embodiments will define additional fields to prevent putting more than one accessible data item in one field. In any case, processing will have means for knowing whether a value is present or not, and for which field (or sub-field) it is present. Absence in data may be indicated with a null indicator (e.g. −1), or indicated with its lack of being there (e.g. varying length record embodiments). Of course, SQL data embodiments provide convenient methods for storing and accessing data.

Client processing 106 interfaces with the ICW 104 for a variety of search and processing options. Components of imagery collection processing 102 communicate with ICW 104 by way of communications paths (connections) 110. Components of client processing 106 communicate with ICW 104 by way of communications paths (connections) 112. Depending on embodiments, ICW 104 may be connected by way of directly accessed storage, Storage Area Network (SAN) access, cloud based access, network access, service access, or a variety of other methods over connections 110 or 112. Connections 110 and 112 may span large geographical distances, for example over an internet, intranet, or SAN topology. The large distances may also involve a variety of protocols, telephony embodiments, switches, hubs, router configurations, or the like to get data from one place to another, as well known to those skilled in the art. Bidirectional paths/connections may be used, or separate unidirectional communications paths/connections may be used, all of which may be over unique topologies of software and hardware to accomplish a communications path. Other communications connections described herein are similarly defined in many connection embodiments just as defined for connections 110 and 112 (i.e. connections 232, 234, 236, 238, 240, 242, 244, 246, 250, 262, 264, 266, 270, 280, 310, 312, 314, 316, etc).

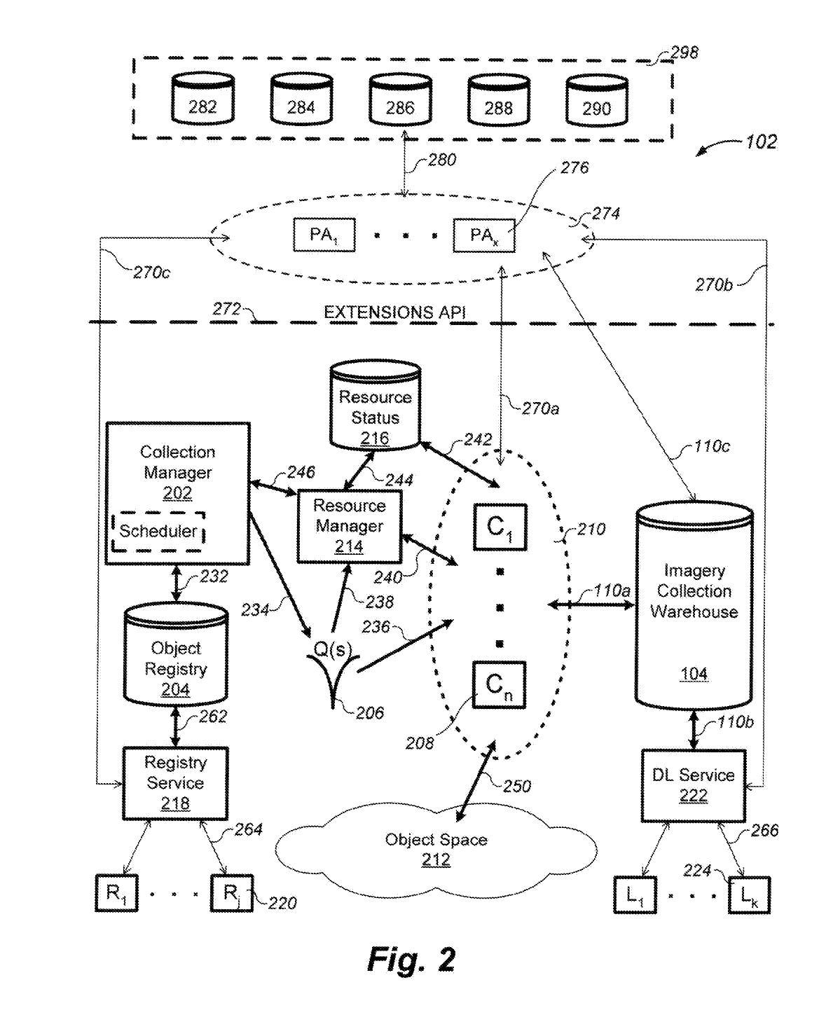

FIG. 2 depicts an architectural diagram describing a preferred embodiment of imagery collection processing 102. A Collection Manager (CM) 202 accesses an Object Registry (OR) 204 by way of connection(s) 232 for determining which imagery objects are to be collected. CM 202 may include a scheduler for timely polling of the OR 204 according to system or user configured time information, may be triggered for collection upon modification of new or altered data in the OR 204, or may poll and support triggering as appropriate. There are various embodiments of CM 202 loop processing on data of the OR 204 to ensure appropriately processing all collection criteria.

OR 204 contains the master of information defining all imagery objects to be collected, such as:
Fully qualified URL names to intranet or internet located files (e.g. http://www.sitename.com/folder1/filename.jpg);
Fully qualified URL names to intranet or internet located files (e.g. http://www.sitename.com/folder2/indxinfo.ptr) for explicitly defining an index file describing individual file names to be accessed;
Fully qualified URL names to intranet or internet located folders (e.g. http://www.sitename.com/folder2) wherein a specially named and anticipated file name exists describing individual file names to be accessed;
Fully qualified URL names to intranet or internet located folders (e.g. http://www.sitename.com) wherein a specially named and anticipated site directory file exists for describing individual file names to be accessed;
Fully qualified storage path name to files (e.g. p:\dir₁\...\dirₘ\name.tif, \\shareAlias\dir₁\...\dirₘ\name.tif, etc.);
Fully qualified storage path name with a wildcard to files (e.g. p:\dir₁\...\dirₘ\nam*.*, \\shareAlias\dir₁\...\dirₘ\nam*.*, etc.);
Fully qualified database connector string having authentication criteria for querying table column(s) to retrieve the imagery information in a format described by the OR entry; and/or
Other criteria for defining one or more imagery content items to be collected.

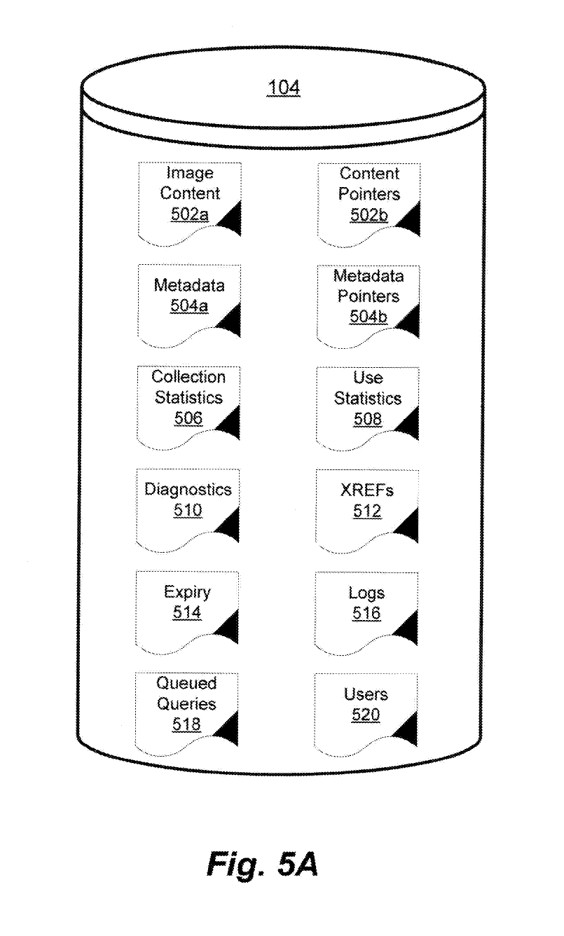

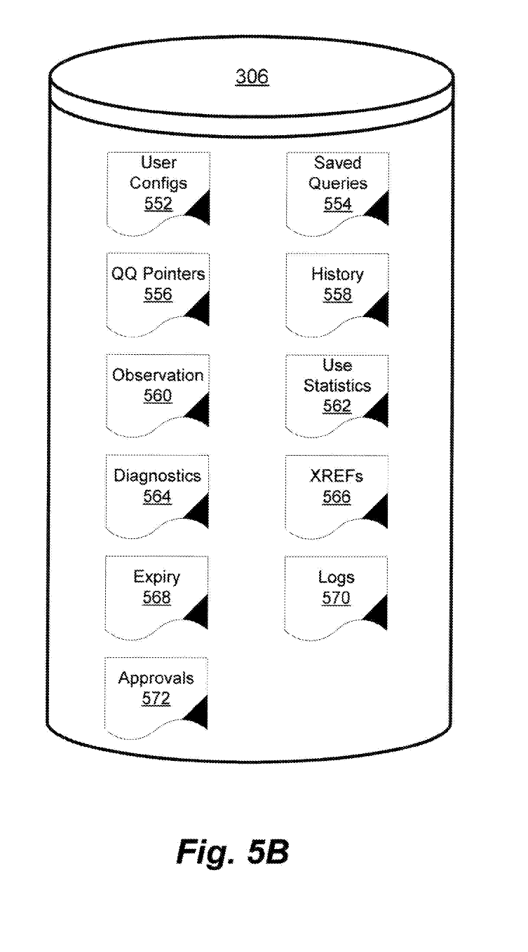

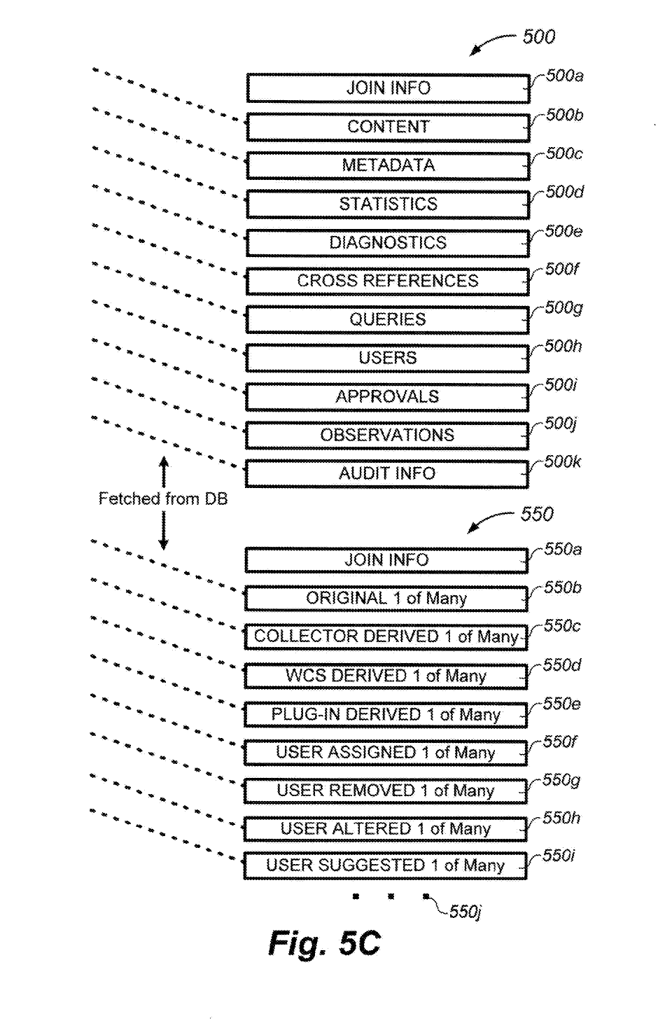

Upon interfacing with OR 204, CM 202 inserts work items by way of connection(s) 234 to queue(s) 206 for one or more collectors, such as a collector 208. A work item will specify exactly what to do (e.g. a collection). A work item may specify what to access in ICW 104 for storing back out to the object space 212, for example with new metadata determined. Preferably, there is a pool of collectors C₁ through Cₙ 208 wherein each collector Cᵢ is a processing thread blocked on queue(s) 206 until an entry is deposited by CM 202, whereupon Cᵢ performs collection from object space 212 by way of connection(s) 250. There are varieties of configurable installations provided for imagery collection processing 102 architectures meeting requirements of a particular installation. Each collector Cᵢ may simply be one of a plurality of threads in a single executable process executing at a single data processing system. Each collector Cᵢ (e.g. 208) may also be one of a plurality of executable processes, which in turn each have one or more threads executing at a particular data processing system. A Cᵢ (e.g. 208) will parse and interpret specialty named index files, files with lists of target files therein, site directory files, wildcards, database references, robots.txt, or any other intermediary means to collect individual file(s). A Cᵢ (e.g. 208) performs processing that may cause it to store data to any of the data of FIG. 5A. Preferably, there is a pool 210 of collectors ready to feed from queue(s) 206 by way of connection(s) 236 for processing all required collections. The pool 210 may be in one data processing system, multiple data processing systems, or data processing systems spread out over great distances from each other, for example using connection embodiments as described above. Queue(s) 206 may be a single large queue, or may include a plurality of queues for enhancing performance of the collectors, and queues 206 may be strategically located on different data processing systems. CM 202 may segregate workloads of collection information to different queues so as to optimize collection processing, for example based on the type of objects being collected, the source of object being collected, or the type of work item to be processed. CM 202 will update OR 204 date/time information for describing the last collection attempt for the particular work item. Collectors Cᵢ preferably observe configurations such as robots.txt files when collecting. Queue(s) 206 may be shared memory or persistent storage based.

Object Space 212 includes sources of imagery information such as the internet, intranet, storage repositories, and the like. Under the most simple of circumstances, a collector inserts by way of connection(s) 110a into ICW 104 the imagery information collected by formatting information to schema of ICW 104 for proper insertion, however see discussion below regarding the extension Application Programming Interface (API) 272. A collector may also store the object back to where it was accessed with automatically determined metadata information, if the OR 204 configuration indicates to do that. In most configured installs of imagery collection processing 102, a Resource Manager (RM) 214 assists with ensuring there are an appropriate number of Cᵢ collectors. The basic RM 214 peeks/polls queue(s) 206 for monitoring a depth of entries by way of connection(s) 238 and throttles up or down by way of connection(s) 240 the number of collectors Cᵢ in pool 210 by starting new ones or terminating existing ones. RM 214 has the ability to ramp up new processing in resources it already controls, but can also ramp up processing (and subsequently ramp down) in pay-by-use cloud attached platforms as needed when standardized resources are not keeping up with necessary performance, thereby expanding pool 210 from standardized resources to extended resources on an as-needed basis. RM 214 is intelligent in managing all resources by maintaining resource status data 216 by way of connection(s) 244. Resource status data 216 contains processing state information of all resources currently in use (standardized and extended) at any particular time. Examination of status data 216 provides a snapshot of all resources currently under control of, and available to, the RM 214 and CM 202. RM 214 allocating additional processing will generally insert information to resource status data 216, and RM 214 removing additional processing will generally remove information from resource status data 216. RM 214 does not rely on polling queue(s) 206 for determining requirements. RM 214 accesses progress statistics and vitals of the collectors' shared memory by way of connection(s) 240 in order to make better judgments of resource requirements. RM 214 and each collector maintain data for resource status 216. In a preferred embodiment, CM 202 interfaces with RM 214 to update OR 204 with collection progress of when the collection completed, how it completed (success or error), how long it took to complete, what actually completed out of the queued work item, and other useful work item status.

OR 204 is managed by way of connection(s) 262 for completeness by Registry Service (RS) 218. The terminology “service” (e.g. RS 218) may be referred to as server(s) 218 or service(s) 218 depending on the reader's point of view (hardware or software), and there may be one or more instances (e.g. threads) thereof to satisfy demands of requesting clients (e.g. 220) by way of connection(s) 264. Other service entities described herein are similarly defined as defined for service 218 (i.e. service 222, 302, etc). In fact, all processing entities are themselves services, and are configured for operation similarly by at least one process on one data processing system (with at least one thread) to many processes across one or more data processing systems (many threads), perhaps interoperating with connection embodiments as described above (i.e. RS 218, DS 222, WCS 302, CM 202, RM 214, etc). A requesting client (e.g. 220) is a MRS, laptop, mobile data processing system, personal computer, or the like, and preferably has a browser based Graphical User Interface (GUI) provided by RS 218 for managing OR 204. In an alternate embodiment, a client/server architecture (e.g. native mobile application) is implemented for supporting requesting clients (e.g. 220). Clients (e.g. 220) are authenticated with credentials for access to OR 204, and RS 218 coordinates, validates, and enforces restrictions to ensure data is in a usable and appropriate format. While RS 218 provides the GUI interfaces for populating information to OR 204, such GUI interfaces may sometimes be cumbersome for large amounts of data. RS 218 additionally supports validating and accepting scripted input from authorized client sources for mass amounts of data to be populated to OR 204.

RS 218 supports registration of new collection configurations, un-registering existing collection configurations, or altering information of existing collection configurations. A user may configure when and how to make copy(s) (e.g. may invoke transforms for translating between different imagery data types), use of pointer(s), timeliness of when to do collections, and other collection parameters. A user hierarchy is additionally provided for authorized approval of proposed configurations by a user. The hierarchy provides at least a root user authority and regular user authority, however more levels may be implemented. For example, trusted users (root users) get complete access to all user interfaces of RS 218, but untrusted users (regular users) submit inactivated configurations which must be approved by a root user in order to be activated/enabled.

Collectors Cᵢ are the most common methods of populating data to ICW 104 when accepting information from requesting clients 220. A Direct loader Service (DS) 222 is additionally provided for populating ICW 104 by way of connection(s) 110b directly from loading clients by way of connection(s) 266, for example loading client 224. In a most common use, a loading client (e.g. 224) is used by a representative user of the present disclosure company that installed imagery collection processing 102, so that little validation is needed when importing or inserting schema understood data into ICW 104. DS 222 further provides a GUI browser and scripting interfaces for untrusted use, similarly as described for RS 218, except data is validated and translated for directly populating schema of ICW 104. Data inserted may be forced for approval before becoming usable.

Collectors Cᵢ (e.g. 208) populate into ICW 104 data described by FIG. 5A. The present disclosure supports third party plug-ins and proprietary algorithms for analyzing and populating ICW 104 schema to enhance usability of the imagery data. Each collector invokes the extension API 272 by way of connection(s) 270a with parameters for special processing of imagery data. DS 222, RS 218, WCS 302, and BAGs 312 may have direct access to API 272 by way of connection(s) 270 for leveraging artificial intelligence plug-in processing when loading, creating, altering, and removing data from, any of the present disclosure data and information. Plug-in processing through API 272 typically performs imagery object transformations, analyzes and reports metadata processed, and can conceivably perform any processing required. Plug-in Agent PAₓ 276 and any Plug-in Agent PA, (e.g. 276) can be viewed as collector Cᵢ, DS 222, RS 218, WCS 302, or BAGs 312 processing when invoked therefrom, and Cᵢ, DS 222, RS 218, WCS 302, or BAGs 312 may already include many proprietary processing methods.

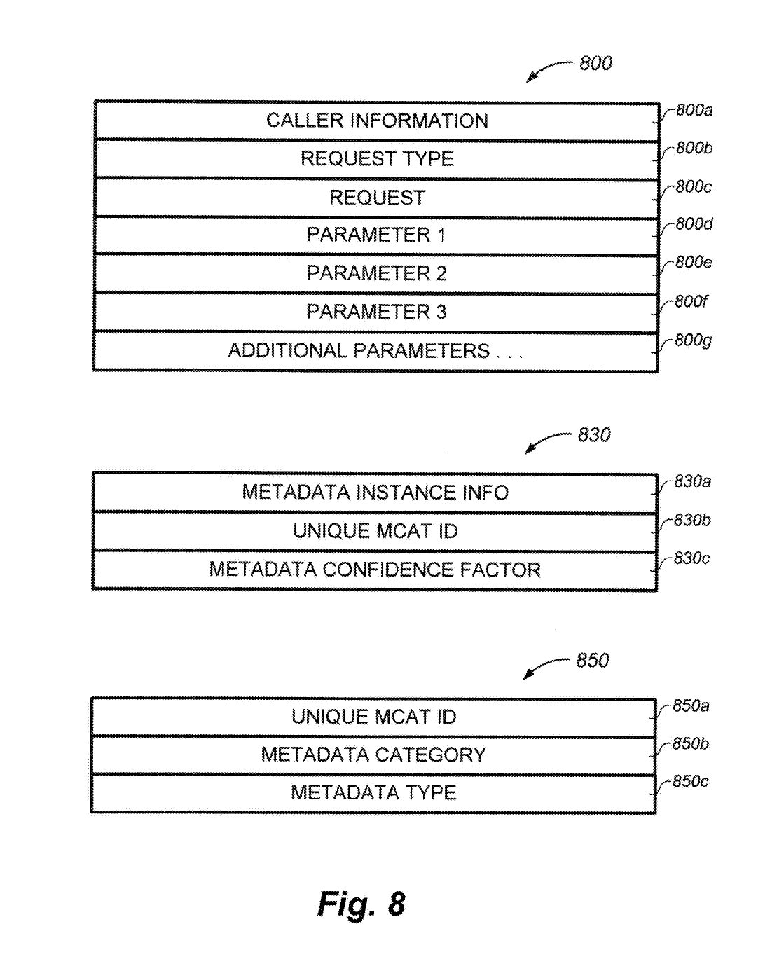

With reference now to FIG. 8, depicted is an illustration for describing standardized parameters passed to a preferred embodiment of plug-in processing. Parameters 800 include caller information 800a for identifying the caller (e.g. collector, WCS 302, loader, analysis, or any other identifier for identifying the caller and perhaps reason for invocation), a request type 800b (e.g. URL, DLL, RPC, etc), request data 800c, and parameters 800d through 800g used as needed for API processing. URL processing is the preferred API method wherein a Service Oriented Architecture (SOA) http or https interface is invoked, preferably with XML and/or HTML data for embodying parameters (e.g. type 800b=URL, request 800c=detailed URL string, parameters may be used as needed for XML build). A Dynamic Link Library (DLL) interface or Remote Procedure Call (RPC) may be used, depending on request type 800b, over various connection embodiments already described above.

Parameters 800 will include reference to imagery object content (e.g. pointer to content), and different parameters for different types of metadata. Pointers may be memory addresses where the data lives, or may be a unique key in a database table column for retrieving data by plug-ins having coded knowledge of ICW 104 schema. Parameters 800 may include new metadata for defining metadata to identify by plug-in processing, metadata inconsistencies, new/altered/generated metadata, etc. Metadata can be represented in different embodiments of data structures after being accessed with an SQL query, but regardless each metadata instance may have many Metadata Instance Descriptors (MIDs) such as Metadata Instance Descriptor (MID) 830.

MID 830 includes metadata instance information 830a (i.e. unique metadata identifier linking to other metadata information such as: data type, data length, actual value or pointer thereof, etc), metadata category identifier 830b, and metadata Confidence Factor (CF) 830c. A single metadata instance may be in many metadata categories, each with its own CF in the context of that category (and type) for indicating a quantifiable accuracy of metadata for the particular imagery object. For example, a negative value indicates the metadata was originally attached to the content, and a positive value indicates the percentile of being accurate. 100% indicates the particular metadata is absolutely certain for describing the object. 99% indicates the particular metadata is absolutely certain from a processed-derived standpoint that the metadata is acceptable. Other values describe an assigned confidence for the metadata associated with the content (e.g. 50%). There are many metadata categories, for example as maintained by Metadata CATegory record (MCAT) 850. MCAT 850 includes a unique primary key 850a, a category description 850b and type description 850c. A single category may have multiple types.

With reference back to FIG. 2, collector Cᵢ invocation of API 272 may cause processing such as Plug-in API PAₓ 276 to populate ICW 104 (e.g. by way of connection(s) 110c if ICW 104 schema is known by the plug-in, or preferably by return of processed data to the invoker Cᵢ and then by way of connection(s) 110a) with or without additional information for enhancing usability of the imagery data. The extension API 272 may be statically linked or dynamically linked (e.g. DLL) with a collector C. API 272 execution determines using the parameters which PAᵢ should be invoked. As new hardware or software platforms are developed, replacement technologies or new versions of the software are easily adapted. PAᵢ interfaces are plugged in for special processing.

API 272 hosts plug-in API interfaces without rebuilding code of API 272. The PAᵢ plug-in APIs are plugged in by API 272 having host processing code to parse and process parameters (e.g. metadata) for properly directing the invocation (e.g. URL, DLL, RPC). A return code is always returned to the caller (e.g. collector Cᵢ) and parameters may be passed by reference for modifying data of the parameters. In an object oriented embodiment, an object may be passed back to the caller.

Each PAᵢ may access processing support data 298 including geocoding information 282, geofence information 284, facial recognition information 286, object recognition information 288, or other leverage information 290 by way of connection(s) 280. Each Cᵢ (or other caller) may also access the processing support data 298 directly (not shown). Geocoding information 282 supports translations of input location information in a first format (e.g. provided by a PAᵢ) with producing a requested output location information in a second format (e.g. for use by the PAᵢ), for example converting a latitude and longitude to a zip code. Geocoding information 282 can be used to translate between any of the following formats: latitude and longitude, address information, zip code, state, country, continent, ip address, named landmarks, logically named places on earth, or any other reasonably converted location data. Geofence information 284 supports translations of input location information in a first format provided for producing requested output location information in a second format, for example converting a latitude and longitude to a zip code. Geofence information 284 can be used to translate between any of the following formats: latitude and longitude, address information, zip code, state, country, continent, ip address, named landmarks, logically named places on earth, or any other reasonably converted location data which is first represented by a geofence, for example originating from a map interface. Facial recognition information 286 contains facial recognition criteria and associated person data whereby the criteria is used to compare to imagery data for determining a feasibility of identifying a person in an image, as well known to those skilled in the art. Object recognition information 288 contains object recognition criteria and associated object data whereby the criteria is used to compare to imagery data for determining a feasibility of identifying an object in an image, as well known to those skilled in the art. Object recognition information 288 is preferably integrated with facial recognition information 286 for performing convenient joins of data, for example to identify a person having a known tattoo or birthmark. Object recognition information 288 includes criteria for searching images for objects including and not limited to buildings, cars, boats, tattoos, mountains, license plates, cloud formations, worn jewelry, hard (printed) documents, soft documents (such as Word, Excel, PDF), landscapes, skylines, hair style, houses, clothing, pets, luggage, or any other object depending on a particular application. Other leverage information 290 comprises any useful data which facilitates processing images for populating ICW 104 to enhance usability of the imagery data for a wide range of applications. Data of 282, 284, 286, 288 and 290 may be tightly integrated to imagery collection processing 102, may be provided by third parties and accessed when needed, and may further have a front end service for satisfying requests to the data. Data 298 includes any data that supports artificial intelligence PAᵢ plug-in processing.

ICW 104 stores imagery or video data, with or without associated sound wherein WCS 302 can access and operate on individual frames of a video, and can operate on any associated sound datastreams. All modern imagery types and video types are supported, and future formats are supported with extension API 272.

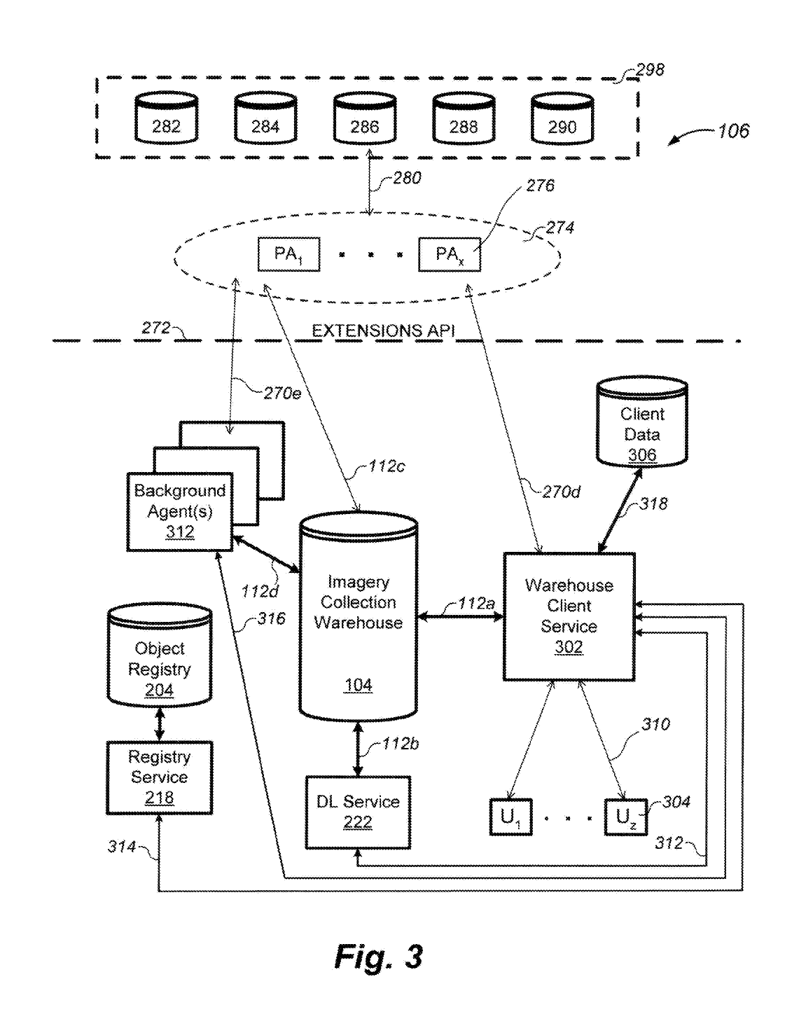

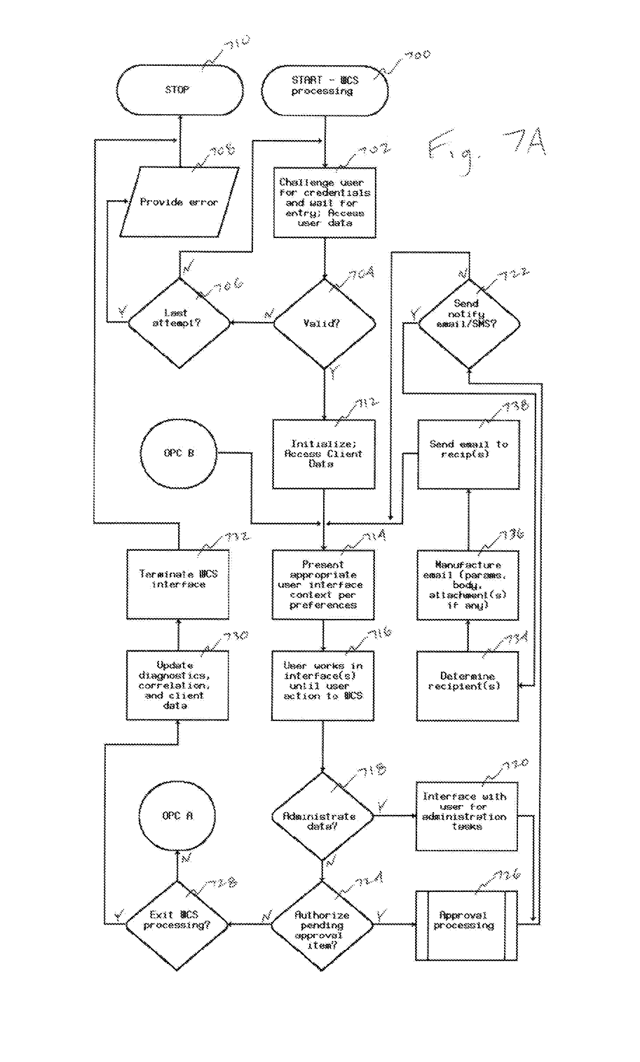

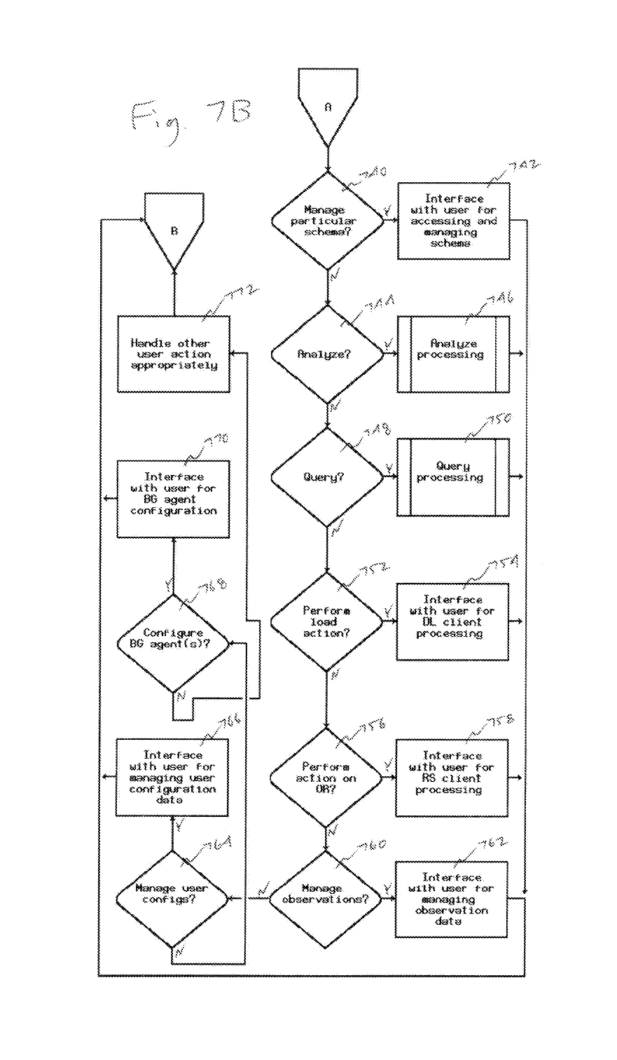

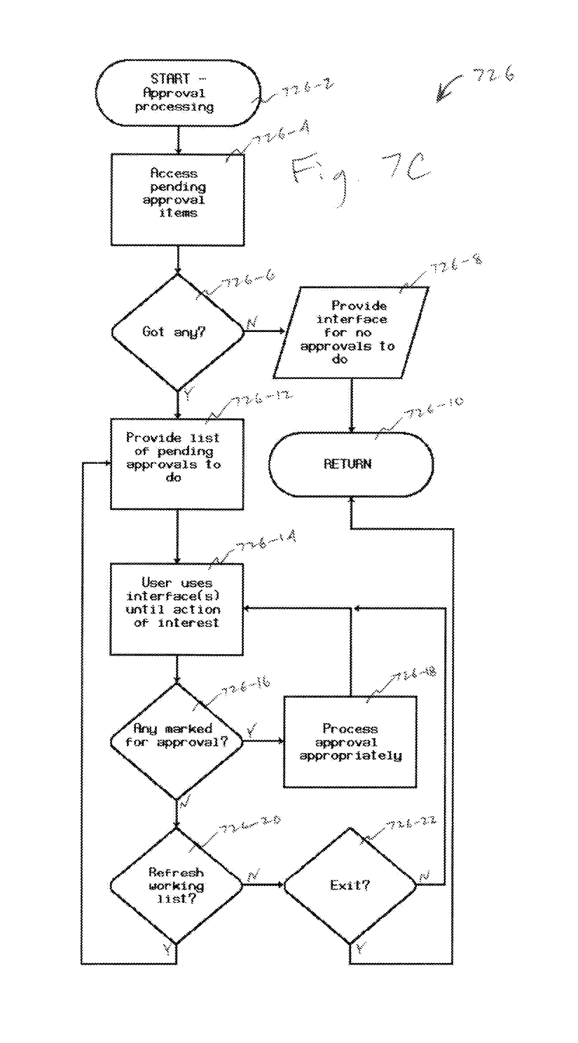

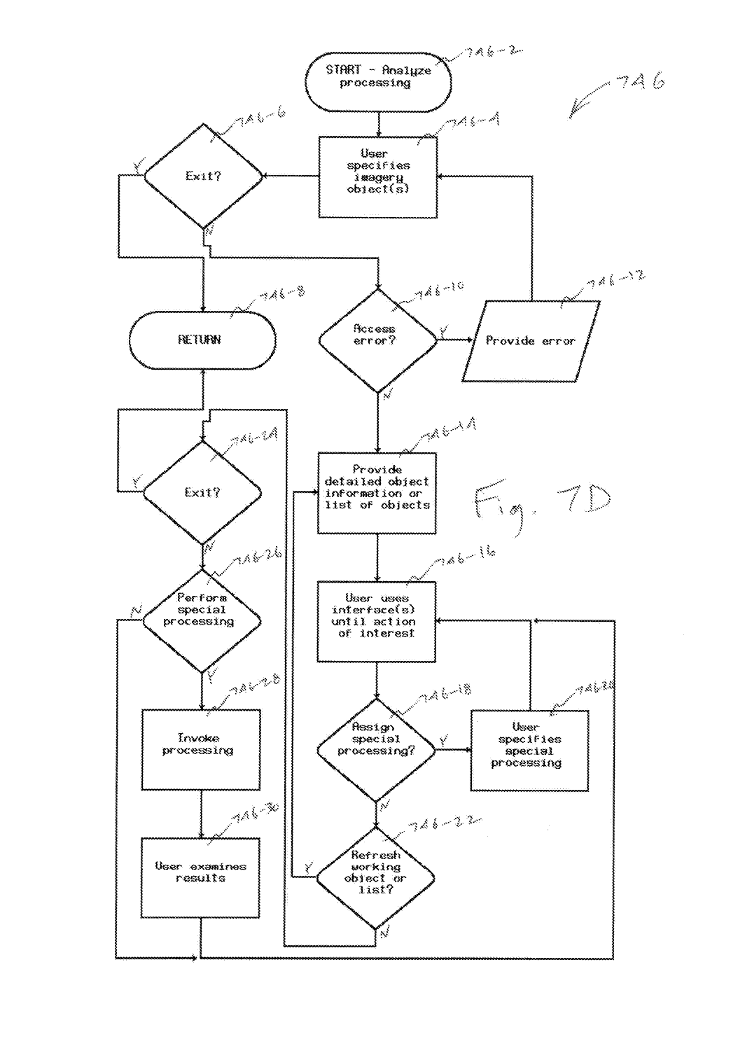

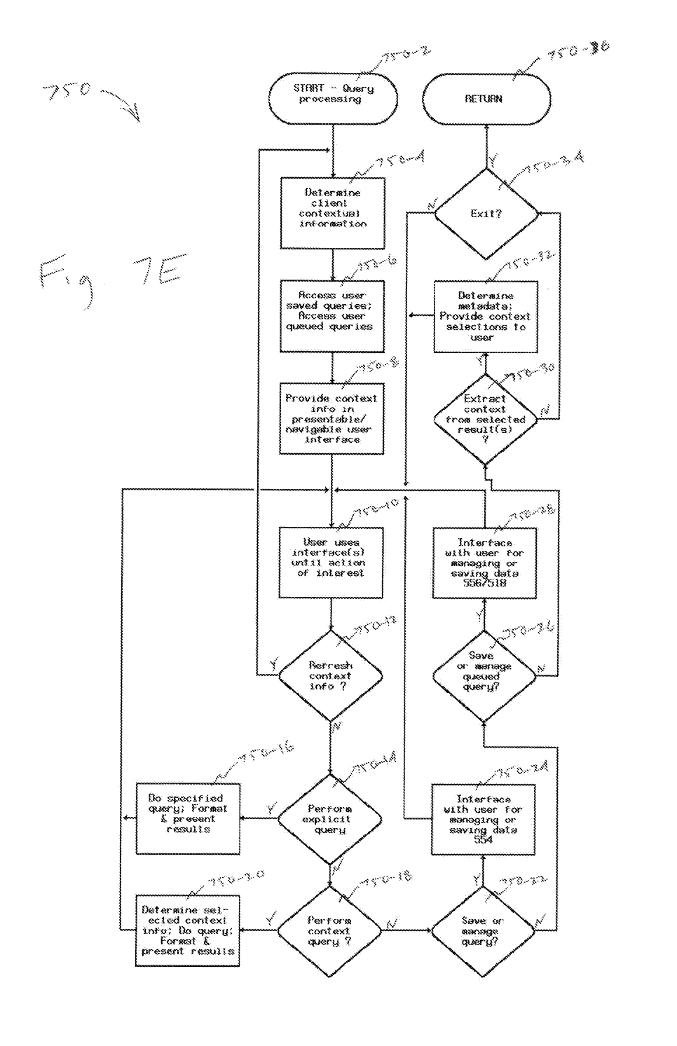

FIG. 3 depicts an architectural diagram describing a preferred embodiment of client processing 106. A user interfaces to the ICW 104 through a Warehouse Client Service (WCS) 302. For example, a user client 304 interfaces to WCS 302 by way of connection(s) 310 for searching and interacting with ICW 104 by way of connection(s) 112a. A client 304 is a MRS, laptop, mobile data processing system, personal computer, or the like, and preferably has a browser based GUI provided by WCS 302 for interfacing to data of ICW 104. In an alternate embodiment, a client/server architecture (e.g. native mobile application) is implemented for supporting ICW clients (e.g. 304). Clients (e.g. 304) are authenticated with credentials for access to ICW 104, and WCS 302 coordinates, validates, searches, and thereby facilitates imagery based functionality. While WCS 302 provides GUI interfaces, such interfaces may sometimes be cumbersome lots of activity. WCS 302 additionally supports accepting a scripted command language from authorized clients (e.g. 304) for desired imagery processing features. WCS 302 maintains client data 306 for each client user (e.g. 304) by way of connection(s) 318. Client data 306 is described by FIG. 5B. WCS 302 provides user interfaces described by FIGS. 7A to 7E.

WCS 302 additionally interfaces with DS 222 by way of connection(s) 312 and RS 218 by way of connection(s) 314 as required by the user so that WCS 302 users of clients such as client 304 have access to the same client functionality already described thereof (e.g. by SOA XML interface). Some embodiments combine all client user interfaces (e.g. RS 218 clients (e.g. client 220), DS 222 clients (e.g. client 224), WCS 302 clients (e.g. client 304)) through a common service for all client activity (e.g. through WCS 302, or other common service). Users of WCS 302 can save and access imagery information for the benefit of other users for true social interaction, depending on the application of client processing. Also, WCS 302 manages Background Agents (BAGS) 312 by way of connection(s) 316 for grooming, archiving, and transforming ICW 104 data.

The present disclosure supports third party plug-ins and proprietary algorithms for processing ICW 104 data to enhance usability of the imagery data, and for processing specifications by users. WCS 302 invokes the extension API 272 by way of connection(s) 270 with parameters 800 for further processing data with third party or proprietary processing. The imagery collection processing 102 and client processing 106 architectures are intentionally flexible for extension plug in API processing, thereby providing choices for balancing pre-processing the imagery data at collection time for facilitating WCS 302 access and searches versus post-processing the imagery data for access and searches in real-time for good performance, or with BAGs 312 (e.g. background grooming by analyzing imagery objects and adding metadata to the imagery objects). Audit data recorded makes use of parameters 800 for knowing who invoked which API at what time and for what reason with particular results.

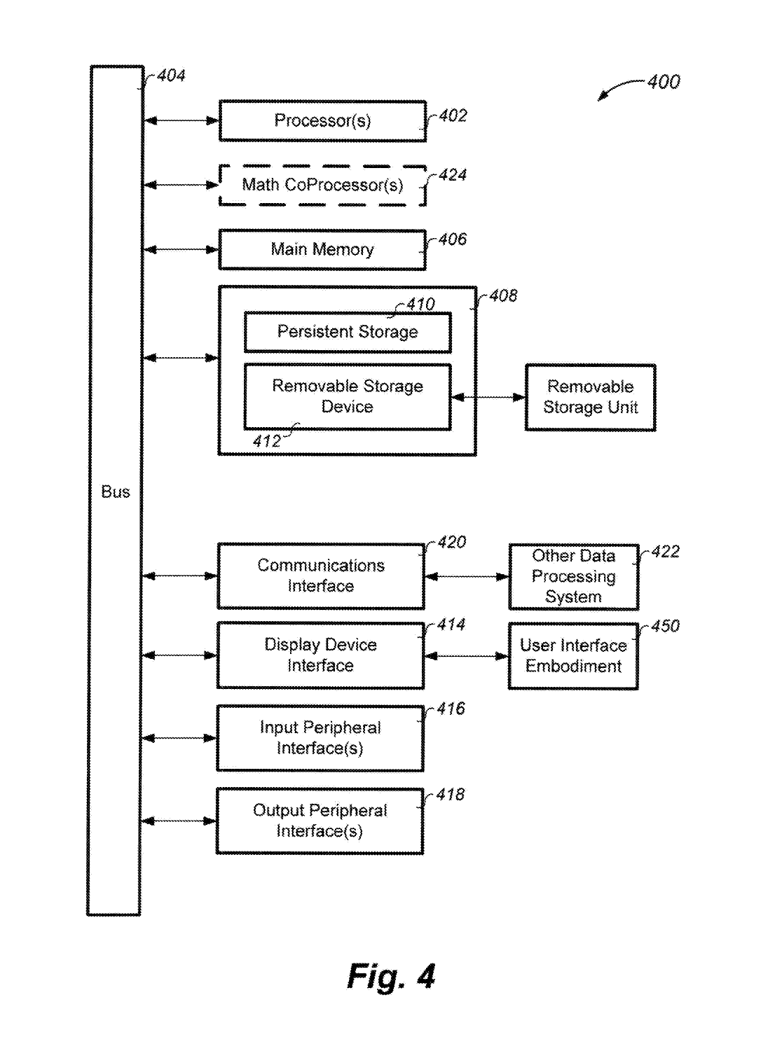

FIG. 4 depicts a block diagram of a data processing system useful for implementing a MRS, a service, a collector, a manager, or any other data processing system of the present disclosure for carrying out disclosed processing or functionality. A device or system (e.g. a mobile data processing system) accessing any user interface or GUI of the present disclosure may also be a data processing system 400. A data processing system 400 includes at least one processor 402 (e.g. Central Processing Unit (CPU)) coupled to a bus 404. Bus 404 may include a switch, or may in fact be a switch 404 to provide dedicated connectivity between components of data processing system 400. Bus (and/or switch) 404 is a preferred embodiment coupling interface between data processing system 400 components. The data processing system 400 also includes main memory 406, for example, random access memory (RAM). Memory 406 may include multiple memory cards, types, interfaces, and/or technologies. The data processing system 400 may include secondary storage devices 408 such as persistent storage 410, and/or removable storage device 412, for example as a compact disk, floppy diskette, USB flash, or the like, also connected to bus (or switch) 404. In some embodiments, persistent storage devices could be remote to the data processing system 400 and coupled through an appropriate communications interface. Persistent storage 410 may include flash memory, disk drive memory, magnetic, charged, or bubble storage, and/or multiple interfaces and/or technologies, optionally in software interface form of variables, a database, shared memory, etc.

The data processing system 400 may also include a display device interface 414 for driving a connected display device (not shown) and user interface embodiment 450. The data processing system 400 may further include one or more input peripheral interface(s) 416 to input devices such as a keyboard, keypad, Personal Digital Assistant (PDA) writing implements, touch interfaces, mouse, voice interface, or the like. User input (“user input”, “user events” and “user actions” used interchangeably) to the data processing system are inputs accepted by the input peripheral interface(s) 416. The data processing system 400 may still further include one or more output peripheral interface(s) 418 to output devices such as a printer, facsimile device, or the like. Output peripherals may also be available via an appropriate interface.

Data processing system 400 may include communications interface(s) 420 for communicating to another data processing system 422 via analog signal waves, digital signal waves, infrared proximity, copper wire, optical fiber, or any other reasonable method including Bluetooth, NFC, WiFi, or by way of any communications protocol. A data processing system 400 may have multiple communications interfaces 420 (e.g. cellular connectivity, 802.x, LAN/MAN/WAN interface, etc). Other data processing system 422 may be another data processing system 400, or a mobile data processing system. Other data processing system 422 may be a service.

Data processing system programs (also called control logic) may be completely inherent in the processor(s) 402 being a customized semiconductor, or may be stored in main memory 406 as instructions for execution by processor(s) 402 as the result of a read-only memory (ROM) load (not shown), or may be loaded from a secondary storage device into main memory 406 for execution by processor(s) 402. Such programs, when executed, enable the data processing system 400 to perform features of the present disclosure as discussed herein. Accordingly, such data processing system programs represent controllers of the data processing system, for example having coded executable is instructions for defining a program product of the present disclosure.

In some embodiments, the disclosure is directed to a control logic program product comprising at least one processor 402 having control logic (software, firmware, hardware microcode) stored therein. The control logic, when executed by processor(s) 402, causes the processor(s) 402 to perform operations and provide functions of the disclosure as described herein. In another embodiment, this disclosure is implemented primarily in hardware, for example, using a prefabricated component state machine (or multiple state machines) in a semiconductor element such as a processor 402. Furthermore, data processing system 400 may include at least one math coprocessor 424 for expedient mathematical calculations and imagery processing. The different embodiments for providing control logic, processor execution, processing code, executable code, semiconductor processing, software, hardware, combinations thereof, or the like, provide processing means for the present disclosure, for example as described herein, and by flowcharts.

Those skilled in the art will appreciate various modifications to the data processing system 400 without departing from the spirit and scope of this disclosure. A data processing system preferably has capability for many threads of simultaneous processing which provide control logic and/or processing. These threads can be embodied as time sliced threads of processing on a single hardware processor, multiple processors, multi-core processors, Digital Signal Processors (DSPs), or the like, or combinations thereof. Such multi-threaded processing can concurrently serve large numbers of concurrent tasks. Concurrent processing may be provided with distinct hardware processing and/or as appropriate software driven time-sliced thread processing. Those skilled in the art recognize that having multiple threads of execution is accomplished in many different ways without departing from the spirit and scope of this disclosure. This disclosure strives to deploy software to existing hardware configurations, but the disclosed software can be deployed as burned-in microcode to new hardware.

Data processing aspects of drawings/flowcharts are preferably multi-threaded so that many applicable data processing systems are interfaced with in a timely and optimal manner. Data processing system 400 may also include its own clock mechanism (not shown), if not an interface to an atomic clock or other clock mechanism, to ensure an appropriately accurate measurement of time in order to appropriately carry is out processing described below. In some embodiments, Network Time Protocol (NTP) is used to keep a consistent universal time for data processing systems in communications with data processing system 400. However, appropriate time conversions are made to accommodate different data processing systems 400 in different time zones.

In some embodiments, components of data processing system 400 may be spread out and interconnected using a plurality of different data processing systems, for example by connection embodiments described above.

FIG. 5A depicts an illustration for describing a preferred embodiment of data maintained to ICW 104. Such data originates from users, security camera topologies and system, archives, or any other system or storage having imagery data configured in OR 204. ICW 104 contains imagery content 502a, content pointers 502b, metadata 504a, metadata pointers 504b, collection statistics information 506, use statistics information 508, diagnostics information 510, cross reference information 512, expiry information 514, logs information 516 which is not already provided by an SQL implementation, queued queries 518, and user data 520.

Imagery content 502a contains two dimensional imagery data including image types of ANI, ANIM, APNG, ART, BMP, BSAVE, CAL, CIN, CPC, CPT, DPX, ECW, EXR, FITS, FLIC, FPX, GIF, HDRi, HEVC, ICER, IONS, ICO, CUR, ICS, ILBM, JBIG, JBIG2, JNG, JPEG, JPEG 2000, JPEG-LS, JPEG XR, MNG, MIFF, PAM, PBM, PGM, PPM, PNM, PCX, PGF, PICtor, PNG, PSD, PSB, PSP, QTVR, RAS, RGBE, JPEG-HDR, Logluv TIFF, SGI, TGA, TIFF, WBMP, WebP, XBM, XCF, XPM, XWD, CIFF, DNG, ORF, AI, CDR, CGM, DXF, EVA, EMF, Gerber, HVIF, IGES, PGML, SVG, VML, WMF, Xar, as well as any format supportable through extension API 272. Three dimensional image formats may also be supported. Imagery content 502a contains video image data including video types AAF, 3GP, GIF, ASF, AVCHD, AVI, CAM, DAT, DSH, FLV, M1V MPEG-1, M2V MPEG-2, FLA, FLR, SOL, M4V, Matroska, WRAP, MNG, QuickTime (.mov), MPEG (.mpeg, .mpg, .mpe), MPEG-4 Part 14, shortened “MP4”, MXF, ROQ, NSV, Ogg, RM, SVI, SMI, SWF, WMV, as well as any format supportable through extension API 272. Three dimensional video formats may also be supported. The type of imagery content is maintained to at least one metadata instance for content type (i.e. unknown is a valid object type). Sound is treated as an assigned metadata instance, specifically sound is track metadata.

Content pointers 502b contain fully qualified path names, URL names, fully qualified storage addresses, database connector information, or other address information for where imagery content 502a lives for preventing copying of data to ICW 104. An installation may use all pointers 502b, make all copies 502a, or use both methods for maintaining content to ICW 104. Collector processing is minimized by updating pointers in ICW 104 rather than making physical copies. In some embodiments, pointers 502b have associated error status information for describing a collection attempt.

Metadata 504a contains all metadata for a particular instance of imagery data of 502a or 502b with joining information for run-time query correlation. Metadata 504a comprises a large amount of categorized table schema with many tables and columns therein. Metadata is described by MID 830, MCAT 850, and lots of instance information (e.g. offset, instance identifier, data format, length, etc). Some release 1.0 example imagery metadata maintained to metadata 504a includes:

| Item # | Name | Format |
|---|---|---|
| 0x010e | ImageDescription | string |
| 0x010f | Make | string |
| 0x0110 | Model | string |
| 0x0112 | Orientation | unsigned short |
| 0x011a | XResolution | unsigned rational |
| 0x011b | YResolution | unsigned rational |
| 0x0128 | ResolutionUnit | unsigned short |
| 0x0131 | Software | string |
| 0x0132 | DateTime | string |
| 0x013e | WhitePoint | unsigned rational |
| 0x013f | PrimaryChromaticities | unsigned rational |
| 0x0211 | YCbCrCoefficients | unsigned rational |
| 0x0213 | YCbCrPositioning | unsigned short |
| 0x0214 | ReferenceBlackWhite | unsigned rational |
| 0x8298 | Copyright | string |
| 0x8769 | ExifOffset | unsigned long |
| 0x829a | ExposureTime | unsigned rational |
| 0x829d | FNumber | unsigned rational |
| 0x8822 | ExposureProgram | unsigned short |
| 0x8827 | ISOSpeedRatings | unsigned short |
| 0x9000 | ExifVersion | undefined |
| 0x9003 | DateTimeOriginal | string |
| 0x9004 | DateTimeDigitized | string |
| 0x9101 | ComponentConfiguration | undefined |
| 0x9102 | CompressedBitsPerPixel | unsigned rational |
| 0x9201 | ShutterSpeedValue | signed rational |
| 0x9202 | ApertureValue | unsigned rational |
| 0x9203 | BrightnessValue | signed rational |
| 0x9204 | ExposureBiasValue | signed rational |
| 0x9205 | MaxApertureValue | unsigned rational |
| 0x9206 | SubjectDistance | signed rational |
| 0x9207 | MeteringMode | unsigned short |
| 0x9208 | LightSource | unsigned short |
| 0x9209 | Flash | unsigned short |
| 0x920a | FocalLength | unsigned rational |
| 0x927c | MakerNote | undefined |
| 0x9286 | UserComment | undefined |
| 0xa000 | FlashPixVersion | undefined |
| 0xa001 | ColorSpace | unsigned short |
| 0xa002 | ExifImageWidth | unsigned short/long |
| 0xa003 | ExifImageHeight | unsigned short/long |
| 0xa004 | RelatedSoundFile | string |
| 0xa005 | ExifInteroperabilityOffset | unsigned long |
| 0xa20e | FocalPlaneXResolution | unsigned rational |
| 0xa20f | FocalPlaneYResolution | unsigned rational |
| 0xa210 | FocalPlaneResolutionUnit | unsigned short |
| 0xa217 | SensingMethod | unsigned short |
| 0xa300 | FileSource | undefined |
| 0xa301 | SceneType | undefined |
| 0x00fe | NewSubfileType | unsigned long |
| 0x00ff | SubfileType | unsigned short |
| 0x012d | TransferFunction | unsigned short |
| 0x013b | Artist | string |
| 0x013d | Predictor | unsigned short |
| 0x0142 | TileWidth | unsigned short |
| 0x0143 | TileLength | unsigned short |
| 0x0144 | TileOffsets | unsigned long |
| 0x0145 | TileByteCounts | unsigned short |
| 0x014a | SubIFDs | unsigned long |
| 0x015b | JPEGTables | undefined |
| 0x828d | CFARepeatPatternDim | unsigned short |
| 0x828e | CFAPattern | unsigned byte |
| 0x828f | BatteryLevel | unsigned rational |
| 0x83bb | IPTC/NAA | unsigned long |
| 0x8773 | InterColorProfile | undefined |
| 0x8824 | SpectralSensitivity | string |
| 0x8825 | GPSInfo | unsigned long |
| 0x8828 | OECF | undefined |
| 0x8829 | Interlace | unsigned short |
| 0x882a | TimeZoneOffset | signed short |
| 0x882b | SelfTimerMode | unsigned short |
| 0x920b | FlashEnergy | unsigned rational |
| 0x920c | SpatialFrequencyResponse | undefined |
| 0x920d | Noise | undefined |
| 0x9211 | ImageNumber | unsigned long |
| 0x9212 | SecurityClassification | string |
| 0x9213 | ImageHistory | string |
| 0x9214 | SubjectLocation | unsigned short |
| 0x9215 | ExposureIndex | unsigned rational |
| 0x9216 | TIFF/EPStandardID | unsigned byte |
| 0x9290 | SubSecTime | string |
| 0x9291 | SubSecTimeOriginal | string |
| 0x9292 | SubSecTimeDigitized | string |
| 0xa20b | FlashEnergy | unsigned rational |
| 0xa20c | SpatialFrequencyResponse | unsigned short |
| 0xa214 | SubjectLocation | unsigned short |
| 0xa215 | ExposureIndex | unsigned rational |
| 0xa302 | CFAPattern | undefined |
| 0x0100 | ImageWidth | unsigned short/long |
| 0x0101 | ImageLength | unsigned short/long |
| 0x0102 | BitsPerSample | unsigned short |
| 0x0103 | Compression | unsigned short |
| 0x0106 | PhotometricInterpretation | unsigned short |
| 0x0111 | StripOffsets | unsigned short/long |
| 0x0115 | SamplesPerPixel | unsigned short |
| 0x0116 | RowsPerStrip | unsigned short/long |
| 0x0117 | StripByteConunts | unsigned short/long |
| 0x011c | PlanarConfiguration | unsigned short |
| 0x0201 | JpegIFOffset | unsigned long |
| 0x0202 | JpegIFByteCount | unsigned long |
| 0x0212 | YCbCrSubSampling | unsigned short |

Metadata 504a contains metadata already available with the imagery data accessed and populated to ICW 104, metadata determined by WCS 302 processing and created/inserted, metadata determined by a collector Cᵢ and created/inserted, metadata determined by a PAᵢ API and created/inserted, metadata determined by DS 222 and created/inserted, metadata created/inserted by BAGs 312, or metadata validated by a user for creation/insertion through WCS 302. Each metadata instance can have many MID 830 records, depending on categories and types of metadata associated to the particular metadata instance. Each unique category and type combination of a metadata instance has an associated Confidence Factor (CF).

Metadata pointers 504b contain full qualified path names, URL names, fully specified storage addresses, or other address information for where metadata datastreams live for preventing copying of data to ICW 104. An installation seldom uses pointers 504b except for large metadata files which can be efficiently accessed, and is where SQL schema is not needed to facilitate searching.

Collection statistics information 506 contains normalized schema describing aspects of collections including the most recent date/time stamp of the particular collected imagery, elapsed time for retrieval, an error for a collection attempt with joined pointer 502b information, a success status for the last collection attempt with joined content and metadata, and other useful information describing data collection. Collection statistics information 506 contains joining information for query correlation to other tables.

Use statistics information 508 contains normalized schema describing aspects of how PAᵢ API's use the ICW 104 data, and recording use of input and output parameters 800. Processing of API 272 inserts records to data 508. This provides business intelligence for directing engineering resources to ‘tweak’ performance configurations for accommodating the most prevalently used user interfaces, features, and processing. Use statistics information 508 contains joining information for query correlation to other tables.

Diagnostics information 510 contains normalized schema describing results of analysis processing through API 272, or any caller thereof. Metadata CF information 830c referenced in diagnostics 510 is under a system configured threshold (e.g. 99%) for acceptable accuracy of metadata. The data generated facilitates a variety of interesting search functionality, because metadata may be newly determined with a specified confidence. Diagnostics information 510 contains joining information for query correlation to other tables.

Cross reference information 512 contains normalized schema describing results of analysis processing through API 272, or any caller thereof. Metadata CF information 830c referenced in cross reference information 512 is equal to or greater than a system configured threshold (e.g. 99%) for acceptable accuracy of metadata. The data generated facilitates a variety of interesting search functionality, because metadata may be newly determined with an acceptable level of confidence. Cross reference information 512 contains joining information for query correlation to other tables.

Expiry information 514 contains normalized schema describing data of other tables wherein the data has an expiration. Expiry information 512 drives periodic pruning is of associated table information which has become obsolete, or is subject to performance constraints, for example using BAGs 312. Data which is expired is moved to an archive so that the ICW 104 maintains a minimal well performing window of searchable information. Expiry information 514 contains joining information for query correlation to other tables.

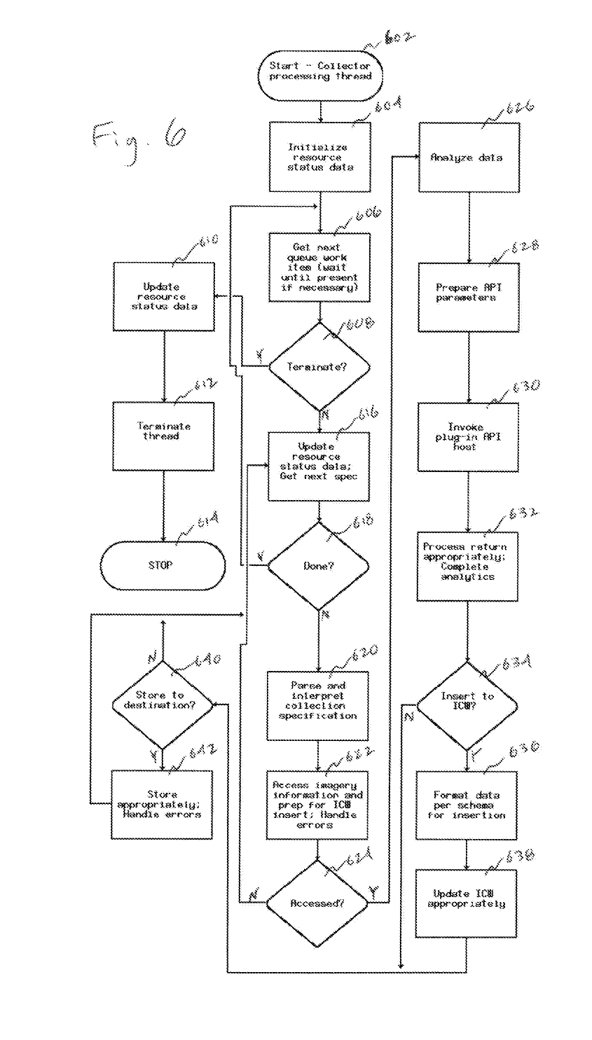

Logs information 516 contains normalized schema describing historical collections of Cᵢ (e.g. 208) activity. Logs information 516 records every Cᵢ action. Blocks of FIG. 6 are inserting records to data 516. Use statistics 508 are essentially summaries of detailed information maintained to logs information 516. Logs information 516 is not to be confused with SQL transaction logs or any other logs already provided in an SQL environment. Logs information 516 contains joining information for run-time query correlation to other tables.

Queued queries 518 contain queries by users of WCS 302 which want to be alerted when a particular query matches information sought. Queries 518 stay pending until data becomes available in ICW 104 matching the query. A user must reset the query after it has been triggered for alerting the user with the search result, and each user is able to set a reasonable pending maximum of queued queries. Queued queries 518 make use of database trigger configurations and contain joining information for query correlation to other tables. Alerts are provided by SMS message, email, or browser context when a user is actively in a WCS 302 interface at the time, in accordance with client configurations 556.

User data 520 contains user credentials (id and password), user level (at least two: root user or not), last time and how accessed, and any required or optional user information, depending on the application installation. In one basic embodiment, new users are added by a root user for new accounts. In an alternate embodiment, a conventional registration and repudiation process is implemented for users to open their own accounts, for example with an email address for user identifiers. A root user can promote data and configurations by regular users to master data for use by all users.

FIG. 5B depicts an illustration for describing a preferred embodiment of data maintained to client data 306. Such data originates from user activity through WCS 302, and there is data representative for every user of WCS 302. Client data 306 contains user configurations 552, saved queries 554, queued query pointers 556, history information 558, observation information 560, use statistics information 562, diagnostics information 564, cross reference information 566, expiry information 568, logs information 570 which is not already provided by an SQL implementation, and approval information 572.

User configurations 552 contain information describing a user's GUI and user interface preferences such as window sizes, fonts, colors, type of default user interfaces upon initial use, and any other aspect for customizing the user interface look and feel for a particular user. Users select their preferred user interface methodology such as wizard-based query building, natural-language entered queries in a preferred language, voice controlled searches, or another appropriate interface. An appropriate GUI reflects the user tastes and preferences. The last used GUI preferences are saved to client data 306 for retrieval for instantiating the preferred GUI at next use. All user interfaces described herein are National Language Support (NLS) enabled with single and double-byte character codes to support all known languages.

Saved queries 554 contain any queries up to a reasonable maximum that a user wants to save between uses of WCS 302, for example to re-perform a search or to continue working on a query for finalization.

Queued query pointers 556 correlate to queued queries 518, if any, and need not be provided when the ICW 104 data can be joined in real time to client data 306, for example by being in the same database. Queued query pointers 556 include how to alert based on triggered queued queries. Queued query pointers 556 will mirror queries 518 when separate databases are used that cannot be joined for good performance.

History information 558 contains archives of logs information 570, for example for law enforcement applications or installations that require precise record-keeping. History 558 provides date/time stamped auditable records of every action a user undertook in client processing 106. Logs information 570 contains the most recent user activity, preferably for a configured number of logged actions in support of an undo function in WCS 302 interfaces. Records are moved to History 558 when undo functionality is unavailable.

Observation information 560 contains normalized schema describing aspects of user feedback from questionnaires and selected user interface paths in using client processing 106. Feedback is preferably multiple choice answers, boolean answers, and discretely defined data points that facilitate automated client processing 106 for is enhancing data of ICW 104, and for informing other users with data processed and report statistics. Free form comments may also be saved for observations. This supports business intelligence for directing engineering resources to tweak performance configurations for accommodating the most prevalently used user interfaces, features, and processing. It also supports collaborative intelligence processing between users for any metadata instance of interest. Observation information 560 contains joining information for query correlation to other tables.

Use statistics information 562 contains normalized schema describing aspects of how users of WCS 302 use the client processing 106. This provides business intelligence summary information for directing engineering resources to ‘tweak’ performance configurations for accommodating the most prevalently used user interfaces, features, and processing. Use statistics information 562 contains joining information for query correlation to other tables.

Diagnostics information 564 contains normalized schema describing results of determining how a user interacts with WCS 302 when analyzing imagery objects for determining metadata. Diagnostics information 564 is promoted by the particular user to his own cross reference information 566 when the CF is adequately high (e.g. 99% or better). Diagnostics information 564 contains joining information for query correlation to other tables.

Cross reference information 566 contains normalized schema describing results of determining how a user interacts with WCS 302 when analyzing imagery objects for determining metadata. Cross reference information 566 is promoted by a trusted user to cross reference information 512 when the CF is adequately high (e.g. 99% or better), or is promoted by a user approving an untrusted user's data 566. Cross reference information 566 contains joining information for query correlation to other tables.

Expiry information 568 contains normalized schema describing data of other tables wherein the data has an expiration. Expiry information 568 drives periodic pruning of associated table information which has become obsolete, or is subject to performance constraints, for example using BAGs 312. Data which is expired is moved to an archive. Expiry information 568 contains joining information for query correlation to other tables.

Logs information 570 contains normalized schema describing historical is collections of user activity of WCS 302. Logs information 570 records every user action in WCS 302 and enables undo functionality for a reasonable and configurable depth of WCS 302 user interface undo ability. Blocks of FIGS. 7A to 7E are inserting records to data 570. Use statistics 562 are essentially summaries of detailed information maintained to logs information 570. Logs information 570 is not to be confused with SQL transaction logs or any other logs already provided in an SQL environment. Logs information 570 contains joining information for query correlation to other tables.

Approval information 572 contains normalized schema describing data of pending approvals for being approved by the appropriate level (e.g. root) user. Approval information 572 contains joining information for query correlation to other tables.

FIG. 5C depicts an illustration for describing joined schema to discuss details of certain data of the present disclosure. Data is joinable with primary keys and/or secondary keys in SQL tables. For example, queries 500 fetch row information 500b through 500k using join information 500a (unique identifier(s)) between schema to correlate data: Content 500b is obtained from data 502a and 502b; metadata 500c is obtained from data 504a and 504b; statistics 500d is obtained from data 506, 508 and 562; diagnostics 500e from data 510 and 564; cross references 500f from data 512 and 566; queries 500g from data 518, 554 and 556; users 500h from data 520 and 552; approvals 500i from data 572, observations 500j from data 560, and audit information 500k from data 514, 516, 558, 568 and 570.

Imagery objects have metadata associated with them. Data is joinable with primary keys and/or secondary keys in SQL tables. For example, metadata queries 550 fetch row information 550b through 550j using join information 550a (unique identifier(s)) between schema to correlate data. Types of metadata are obtained from data 504a and 504b, such as: original metadata (originally attached) 550b; collector derived metadata 550c marked as a particular collector processing determined; WCS derived metadata 550d marked as a particular WCS 302 processing determined; plug-in derived metadata 550e marked as a particular plug-in processing determined; user assigned metadata 550f marked as user assigned; user removed metadata 550g marked as user removed; user altered metadata 550h marked as user altered; and user suggested metadata 550i marked as user suggested. Metadata queries 550 can define many types of stored metadata types 550j (and categories thereof) that can be accessed and processed.

Data of queries 500 and 550 can also be joined in a single query. Some data of FIG. 5C may be more easily joined with a single join identifier, or may require one or more other data entities (e.g. other table data) in order to properly join data together, for example using multiple join information, as well known to those skilled in the art. All data of FIGS. 5A and 5B is correlated together as required, and all data can be correlated either directly with join information or indirectly with multiple join information. SQL joins are easily accomplished when all data is in a single database instance, otherwise SQL query engines such as Informatica products can be used to join separate database instances.

FIG. 6 depicts a flowchart for describing a preferred embodiment of collector thread processing, which starts at block 602 upon thread execution start, and continues to block 604 for initializing resource status 216 data, and block 606 for accessing the next work item from queue(s) 206. If there is no work item to immediately process, block 606 waits for a work item to be placed to the queue 206. Upon retrieval of a queue 206 work item, block 608 checks if the work item indicates to terminate thread processing, in which case processing continues to block 610 for updating resource status 216 data, terminating the thread gracefully at block 612, and terminating collection thread processing at block 614.

If block 608 determines the work item is for being processed, processing continues to block 616. Block 616 updates resource status 216 data and the next collection specification from the work item is accessed. Thereafter, if block 618 determines all specified processing specifications have been processed for the work item, processing continues back to block 606, otherwise processing continues to block 620 where the collection specification is parsed and interpreted, block 622 where the interpreted specification is used to collect object space 212 and/or ICW 104 data, and the collected data is formatted for the appropriate target format. Block 622 handles and logs any errors encountered, if any, before continuing to block 624. If block 624 determines imagery object information was successfully accessed and processed, processing continues to block 626, otherwise processing continues back to block 616.

Block 626 may analyze data using standard collector processing before is continuing to block 628 for preparing API 272 parameters 800, block 630 for invoking API 272 with the parameters 800, block 632 for processing the return from API 272 processing along with completing any standard collector analytics processing, and to block 634. Preferably, a single call to the API 272 handles all required processing, even if multiple plug-in API invocations are performed with unique parameters each 800, and in an a specified order of processing, and with a plurality of suitable return information (otherwise blocks 628, 630 and 632 would be shown as contained in a loop). Blocks 622, 626, 628 and 632 will likely create, remove, ignore, or alter metadata, for example before or after invocation of API 272, and prior to storing relevant information to ICW 104 or object space 212. Block 630 may transform the imagery object(s) from a first format (e.g. PNG) to a second format (e.g. JPG).

If block 634 determines data is to be inserted/altered in ICW 104, then block 636 formats information for schema, block 638 updates the ICW 104 with the data, and processing continues to block 640. Any data of FIGS. 5A and appropriate data of 5B may be updated at block 638. If block 634 determines no ICW 104 data is to be inserted/altered, then block 634 continues to block 640. If block 640 determines data is to be stored at a destination (e.g. store back out to object space 212, or store to database or data disclosed herein), then block 642 stores the imagery object(s) and information appropriately before continuing back to block 616. If block 640 determines data is not to be stored, then processing continues directly back to block 616.

FIGS. 7A through 7E depict flowcharts for describing a preferred embodiment of WCS 302 processing. WCS 302 processing begins at block 700 as the result of a user wanting to use a client (e.g. client 304), and continues to block 702 where an appropriate user interface is provided for challenging the user for his credentials (e.g. id and password). Upon credentials being entered, user data 520 is accessed for checking validity. Thereafter, if block 704 determines credentials are not valid, processing continues to block 706. If block 706 determines the user had too many failed attempts, block 708 provides an error to the user, and WCS processing terminates at block 710. If block 706 determines the user can attempt to re-enter credentials, processing continues back to block 702. If block 704 determines credentials are valid, block 712 initializes and accesses this user's client data 306, block 714 presents the appropriate context user interface for WCS 302 processing up to this point and time, and the user works in WCS 302 user interfaces at block 716 until an action having particular explanation is performed, causing processing to leave block 716 for block 718. Block 702 accesses a cookie at the user's client device to determine if a valid logon was already performed so that the user does not have to reenter credentials. If a cookie is found by block 702 processing and the credentials are determined valid, then block 702 continues to block 712 through block 704, otherwise the user must be challenged directly for entering credentials. Block 712 initialization saves a cookie to the client device (if supported) with a reasonable expiration. A root user level has every FIGS. 7A and 7B option for user interfaces of WCS 302. Some options and user interfaces will not be made available to regular user levels (e.g. blocks 718, 720, 724 and 726 may only be provided to root user).

If block 718 determines the user selected to administrate data, WCS processing 302 interfaces with the user for desired administration tasks, and processing continues to block 722. If block 718 determines the user did not select to administrate data, processing continues to block 724. If block 724 determines the user selected to authorize pending work items awaiting approval, WCS approval processing occurs at block 726 (see FIG. 7C), and processing continues to block 722. If block 724 determines the user did not select to authorize pending work items awaiting approval, processing continues to block 728. If block 728 determines the user selected to exit WCS 302 processing, block 730 updates diagnostics 564, cross reference information 566, and other client data 306, based on any analytics of WCS 302 processing up to this point and time, block 732 terminates the WCS interface, and WCS 302 processing terminates at block 710. If block 728 determines the user did not select to exit WCS 302 processing, then processing continues to block 740 of FIG. 7B by way off-page connector A.

Referring back to block 722, if it is determined that an email (or SMS message) is to be sent based on actions at blocks 720 or 726, processing uses data 550/552 and 572 to determine recipient(s) at block 734, format a distribution at block 736, and send the recipient(s) the distribution (email or SMS message) at block 738 before continuing back to block 714. Distributions are useful for letting people know their data has been approved, or their configuration actions are impacted by administrated changes made at block 720.

With reference now to FIG. 7B, if block 740 determines the user selected to work with database schema, WCS 302 processing at block 742 interfaces with the user for desired schema tasks (e.g. define new categories or types of metadata subject to approval if not root user), and processing continues back to FIG. 7A block 714 by way of off-page connector B. New rows of data for approval resulting at block 742 from a regular user will have an Enabled value set to False, thereby requiring a subsequent approval by an authorized user. Each user may promote their data 564 to 566 at block 742 if CF information permits it. If block 740 determines the user did not select to work with database schema, processing continues to block 744. If block 744 determines the user selected to analyze one or more imagery objects, WCS 302 analysis processing occurs at block 746 (see FIG. 7D), and processing continues back to block 714. If block 744 determines the user did not select to analyze one or more imagery objects, processing continues to block 748. If block 748 determines the user selected to perform query processing, WCS 302 query processing occurs at block 750 (see FIG. 7E), and processing continues back to block 714. If block 748 determines the user did not select to perform query processing, then processing continues to block 752.

If block 752 determines the user selected to use DS 222 functionality, WCS 302 processing at block 754 interfaces with the user for desired DS 222 processing, and processing continues back to block 714. If block 752 determines the user did not select to use DS 222 functionality, processing continues to block 756. If block 756 determines the user selected to use RS 218 functionality, WCS 302 processing at block 758 interfaces with the user for desired RS 218 processing, and processing continues back to block 714. If block 756 determines the user did not select to use RS 218 functionality, processing continues to block 760. If block 760 determines the user selected to manage observation data 560, WCS 302 processing at block 762 interfaces with the user for desired observation processing, and processing continues back to block 714. Observation data processing at block 762 enables users to answer multiple choice questions, respond with boolean answers to questions, generate discretely defined data points with answers to questions, and contribute comments (i.e. data 560) correlated to specific metadata references (i.e. joined correlation information) so that other users can benefit from the observation(s) with regard to metadata analyzed, processed, created, altered, manipulated, etc. If block 760 determines the user did not select to manage observation is data 560, processing continues to block 764. If block 764 determines the user selected to manage data 552, WCS 302 processing at block 766 interfaces with the user for desired processing, and processing continues back to block 714. If block 764 determines the user did not select to manage data 552, processing continues to block 768. If block 768 determines the user selected to configure BAGs 312, WCS 302 processing at block 770 interfaces with the user for starting or terminating BAGs 312, and processing continues back to block 714. If block 768 determines the user did not select to configure BAGs 312, processing continues to block 772 where any other action leaving block 716 is handled before processing continues back to block 714.

With reference now to FIG. 7C, block 726 approval processing begins at block 726-2, continues to block 726-4 for accessing pending approvals in data 572, and then to block 726-6. If block 726-6 determines there are no items for approval, then block 726-8 notifies the user, and block 726 processing terminates at block 726-10. If block 726-6 determines there were one or more items for approval, block 726-12 provides the one or more items for approval in a user interface to the user, the user works in WCS 302 user interfaces at block 726-14 until an action having particular explanation is performed, causing processing to leave block 726-14 for block 726-16. Data changes to ICW 104, OR data 204, or user shared client data 306 is subject for higher level (e.g. root) user approval. For example, a regular user defines new metadata, or alters metadata, at block 742, and wants it to be approved for becoming eligible for standard (default) query processing. In another example, a regular user has managed data 564 to cross reference data 566. As soon as the user promotes data from 564 to 566, an approval record gets (triggered) generated for the approving user to promote data 566 to data 512. Any user can promote on his own from data 564 to 566 at block 742. In some embodiments, data 564 may be promoted to data 510 by an approving user.

WCS 302 user interfaces at block 726-14 will present details and helpful supporting information for facilitating approval processing. If block 726-16 determines the user marked one or more pending items for approval, block 726-18 modifies each status from pending approval to approved. Subsequently, cross reference information 566 may be promoted to data 512. Processing leaves block 726-18 for block 726-14. If block 726-16 determines there are no items for approval, then processing continues to block 726-20. If block 726-20 determines the user selected to refresh any items for approval, processing continues back to block 726-12, otherwise processing continues to block 726-22. If block 726-22 determines the user wanted to exit approval processing, then processing continues to block 726-10 where block 726 processing terminates, otherwise processing continues back to block 726-14. Every individual instance of metadata, every referenceable atomic data item, any organization of schema, any ICW 104 data, any appropriate client data 306, new records 830 or 850, and any data joined thereof, can be subject for approval. A preferred SQL embodiment carries a column “Enabled” with each row of data in a table which is subject to approval. The “Enabled” column contains a value for False when not approved yet, and a value for True when approved. A True value makes the row of data visible for inclusion in standard (default) query processing. Trusted users enter rows of data with “Enabled” already set to True.

With reference now to FIG. 7D, block 746 analyze processing begins at block 746-2, continues to block 746-4 for interfacing with the user for specification of imagery object(s), and continues to block 746-6. If block 746-6 determines the user selected to exit block 746-4 specification processing, then block 746-8 terminates block 746 processing. If block 746-6 determines exit was not selected, processing continues to block 746-10. If block 746-10 determines the specified imagery object(s) cannot be accessed, then an error is provided to the user at block 746-12, and processing continues back to block 746-4. If block 746-10 determines the specified imagery object(s) were accessible, then block 746-14 provides the detailed information about the object(s) (e.g. user can see or navigate to the content and metadata associated to the content, as well as the applicable ICW 104 schema), and the user works in WCS 302 user interfaces at block 746-16 until an action having particular explanation is performed, causing processing to leave block 746-16 for block 746-18. If block 746-18 determines the user selected to assign special processing to further analysis, then block 746-20 interfaces with the user for removing, altering, or assigning metadata information (e.g. records 830 or 850, or data 504, 564, 566, or 560), and parameters 800 for API 272 invocation(s). Block 746-20 continues back to block 746-16. If block 746-18 determines no special processing was to be assigned, processing continues to block 746-22. If block 746-22 determines the user selected to refresh the imagery object information, processing continues back to block 746-14, otherwise is processing continues to block 746-24. If block 746-24 determines the user wanted to exit analyze processing, then processing continues to block 746-8, otherwise processing continues to block 746-26. If block 746-26 determines the user selected to perform special processing (e.g. designated at block 746-20), processing continues to block 746-28 to invoke prescribed processing, block 746-30 interfaces with the user to examine results, and processing continues back to block 746-16. Special/prescribed processing performed includes invoking any of the plug-in APIs through API 272 in order to examine metadata finds, validations, and suggestions, along with CF information. The user examines metadata at block 746-30 and may choose to get approvals for data 566 to be promoted to data 512. The user may also choose to get approvals for new or altered data 504. A high level user can make changes without an approval. A user may also promote data 564 to 566 for automatically generating an approval request (if not a trusted user) based on analysis processing.

A user can, with a client to WCS 302, upload, scan, or point to image or video data for being analyzed by WCS 302 to determine available metadata that can be derived, wherein the WCS 302 user interface reports metadata identified and reported as associated to the image or video data, with highlighted likelihood correctness displayed with Confidence Factor (CF) percentage information for describing accuracy of determining the particular metadata instance(s). A user is given the option for which metadata instances should or should not be added to ICW 104 with the image or video data in order to best associate metadata. The user examines CF 830c information for the plurality of individualized metadata instances in order to make decisions for ICW 104 inserts or alterations, for example allowing the user to decide if the image should be further manipulated, processed, or saved to ICW 104. The user may add metadata for subsequent processing. The WCS 302 executable(s) or extension API 272 discussed above may do the processing to determine candidate metadata to be associated, thereby allowing the image to be saved to ICW 104 with additional information of a determined Confidence Factor (CF).

With reference now to FIG. 7E, block 750 query processing begins at block 750-2, continues to block 750-4 for determining client contextual search criteria of the client data processing system (e.g. MRS 304), and then to block 750-6. Client contextual is search criteria includes: an automatically detected location (e.g. lat and long) of the client data processing system (e.g. MRS); current date/time; most recent imagery information saved, altered, created; or any other automatically detected condition of the client data processing system upon encounter to block 750-4.

FIG. 7E processing supports functionality for explicit queries, context queries, queued queries, recursive queries, and saving or managing queries for subsequent use. Explicit queries are entered in their entirety by a user for searching ICW 104 or client data 306 without any context information used. Context queries use contextual information of the user's device (e.g. location, time, etc) and/or contextual information in a result from a previous query, or the user's activities up to the particular point and time of processing (e.g. queries entered thus far). Recursive queries occur when a user updates context information to include results from a previous query, for example using metadata produced from one image to qualify metadata in a query for other images. Queued queries are for triggered processing when the query result (e.g. data inserted to ICW 104) becomes present at a future time.

Block 750-6 accesses the user's data 554, 556 and 518 before continuing to block 750-8 for presentation to the user of all context information up to this point and time in processing. Preferably, context information presented is viewable and navigable by the user for at least categories of user's queries (data 554, 556 and 518), automatically determined client data processing system conditions (detected at block 750-4), and any metadata results of queries already used by the user in FIG. 7E processing (upon issuing queries and extracting metadata search criteria at block 750-32 discussed below). Thereafter, block 750-10 interfaces with the user until an action having particular explanation is performed, causing processing to leave block 750-10 for block 750-12.

If block 750-12 determines the user selected to refresh context information up to this point and time in processing, then processing continues back to block 750-4, otherwise processing continues to block 750-14. For example, the user may be traveling, and a current location at this time is needed for subsequent context query processing. If block 750-14 determines the user built an explicit query at block 750-10, then block 750-16 performs the query (i.e. search of data 104 and/or 306), formats the results, and the results are presented to the user. Thereafter, the user works with the results back at block 750-10. If block 750-14 determines the user did not select to issue an explicit query at is block 750-10, then processing continues to block 750-18. If block 750-18 determines the user selected to issue a context query at block 750-10, then block 750-20 determines the context information selected by the user to finalize the query, performs the query (i.e. search of data 104 and/or 306), formats the results, and the results are presented to the user. Thereafter, the user works with the results back at block 750-10. If block 750-18 determines the user did not select to issue a context query at block 750-10, then processing continues to block 750-22.

If block 750-22 determines the user selected to save or manage query information of data 554, then processing continues to block 750-24 where data 554 is managed. Block 750-24 enables the user to delete, add to, or alter data 554, up to a reasonable system enforced maximum number of saved queries for the particular user of FIG. 7E processing. Block 750-24 also interfaces with the user for invoking an email system or SMS message for including a WCS service interface URL link (i.e. a query object) including one of a selectable number of small graphics (i.e. see emoji.jpg example above) so that recipient(s) can simply click the link and perform the WCS 302 processing of the URL link (e.g. a query to ICW 104 and/or client 306, or any WCS 302 active server page processing the user wants to communicate such as any of FIGS. 7A through 7E service block processing (e.g. blocks 720, 726, 742, 746, 750, 754, 758, 762, 766, 770 or 772). Thus, block 750-24 invokes processing of blocks 734 through 738 as needed. Block 750-24 continues back to block 750-10 for interfacing with the user after updating any context information relevant for queries managed up to this point and time in processing. If block 750-22 determines the user did not select to save or manage a query, processing continues to block 750-26.

If block 750-26 determines the user selected to save or manage queued query information of data 556 and 518, then processing continues to block 750-28 where data 556 and 518 is managed. Block 750-28 enables the user to delete, add to, or alter data 556/518, up to a reasonable system enforced maximum number of saved queued queries for the particular user of FIG. 7E processing. Block 750-28 interfaces with the user for configuring alert criteria such as recipient information, how to deliver the alert when the query is triggered (e.g. email or SMS), and what to deliver with the alert such as the query and results, or a WCS service interface URL link including one of a selectable number of small graphics (i.e. see emoji.jpg example above) so that recipient(s) can simply click the is link and perform the query which was triggered, or optionally load a service page for a processing state of a FIG. 7E block of processing. Thus, block 750-28 enables the user to assign triggered action processing of blocks 734 through 738 as needed for the queued query. Block 750-28 continues back to block 750-10 for interfacing with the user after updating any context information relevant for queries managed up to this point and time in processing. If block 750-26 determines the user did not select to save or manage a queued query, processing continues to block 750-30.

If block 750-30 determines the user selected to update context information using metadata results of a query just executed (e.g. at blocks 750-16 or 750-20), then block 750-32 determines metadata for the imagery result(s) presented and interfaced to by the user at block 750-10 and presents the user with at least the metadata category, type and value of each metadata item for the last completed search result (may be a single image, video, or a plurality of images or videos). The user can then select which metadata to update current context information up to this point and time in processing at block 750-10. The user may select one or more metadata items to add to the current context for forming the next query. For example, one image found in a search result can be conveniently selected to qualify search criteria for the next query to perform. Metadata of the search result is conveniently used for criteria in the next search to perform. This is referred to as a recursive query. Metadata selected may or may not be selected by the user to exactly match metadata of the new search. Options at block 750-10 support user friendly options for searching relative selected metadata, for example for panoramic options of queries discussed below. Thus, metadata is selected to form a next query basis for matching metadata, performing an opposite match to metadata, performing an “in-kind” match to metadata, or performing any other relative relationship of selected metadata for finding imagery data having related metadata in accordance with a user interface option at block 750-10. If block 750-30 determines the user did not select to perform a recursive query, processing continues to block 750-34. If block 750-34 determines the user selected to exit query processing, block 750-36 terminates block 750 processing, otherwise processing continues back to block 750-10 where the user may continue query processing up to this point and time. Useful processing to note which is carried out by FIG. 7E includes the following:
When CF information is not explicitly specified in a query at block 750-10, an is acceptable level of confidence of data is assumed (e.g. system threshold of 99% or above=acceptable level of confidence) for providing standard (default) query processing involving metadata. Low confidence metadata is never assumed as a viable search result for queries performed at block 750-10, unless the user explicitly queries by specifying a confidence factor. In some embodiments, a regular user cannot access low CF data, and only a root user can specify non-standard queries by explicitly specifying CF information (e.g. in an SQL where clause).
The user can get a search result for interface at block 750-10 as a result of: block 750-16 processing; block 750-20 processing; and processing resulting from a recipient user having clicked a query object in an email or SMS message sent by another user by way of block 750-24, by a triggered queued query configured at block 750-28, or a query object sent at block 742.
Find images at the user's current location.
Find images at the user's current location and panoramic images taken at same location with different (relative) fields-of view, directions, or angles of view.
Find images at the user's current location and taken in an opposite direction, or specified tact (relative) to a reference image.
Find images at user's current location at daytime/evening same day of week.
The user can get a search result for interface at block 750-10, and then conveniently specify at block 750-10 a context query (or recursive query) for producing the next search result using metadata of the reference imagery data. For example, the user selects any of a number of panoramic options for a reference image (e.g. of a search result) at block 750-10 (e.g. when arrived to by block 750-32) for producing the next search result—find me other imagery data: taken at this location; facing Northward/Southward/Eastward/Westward at this location; opposite direction of view of reference image at this location; view with number of degrees from due North at location of reference image, or angle and/or heading measurements relative the current reference image location. This allows the user to get any panoramic imagery data that may be relative the reference imagery data, for example at that location, and optionally qualified by the user for evening, morning, or any other reasonable condition for the reference imagery data as specified by the user of FIG. 7E processing.
Users can search ICW 104 using one or more search criteria terms and is conditional operators (e.g. not, and, or, parenthesis, etc), for example in complex queries, for finding image(s), video(s), or subset(s) of video(s) based on the search criteria matching data of images, metadata, sound, or other ICW 104.
Block 750-24 enables insert of a query object for a query of interest or WCS service interface URL link of interest in an outbound email to fellow user(s) as HTML with the underlying URL link for returning WCS 302 query processing results, or for performing any block of WCS 302 processing so as to enable a recipient user to be in a desired WCS 302 context of processing.
Search criteria terms specified by a user can be used to match data in any ICW 104 schema column (e.g. object type=image, video, type of imagery (e.g. jpg), type of video (e.g. avi), etc), and there are many embodiments for normalizing data, combining data, separating out data, and forming new data based on imagery and metadata information to facilitate searching.
Pure Boolean searches are supported using search criteria terms for simply returning a True or False based on presence of sought information.
Find image(s), video(s), or data associated thereof, for example captured at a location specification of a specified continent, country, zip/postal code, city/town/municipality, state/province/federal-district, street address, latitude and/or longitude and/or altitude, geographic area, named geofence from data 284, etc.
Find image(s), video(s), or data associated thereof, for example captured at a location specification above and further qualified with a distance (range) around the location specification (e.g. in meters, kilometers, feet, miles, etc) in order to expand the locations for finding data.
Find image(s), video(s), or data associated thereof containing certain information of databases 282, 284, 286, 288 and 290, as described by metadata.
Find image(s), video(s), or data associated thereof for imagery captured by certain authors, users or other origin identities, as described by metadata.
Find image(s), video(s), or data associated thereof for imagery captured by certain author methods, as described by metadata.
Find image(s), video(s), or data associated thereof for imagery captured by certain equipment criteria or features, for example camera model, cell phone model/type, smartphone type or level of software, etc. as described by metadata.
Find image(s), video(s), or data associated thereof for imagery captured specific times, dates, or within date/time range(s), or having certain date/time stamp(s), as described by metadata.
Find image(s), video(s), or data associated thereof for imagery captured with a specified directional perspective (e.g. clockwise/counter-clockwise degrees relative due North heading) from a specific latitude/longitude, and with optionally an angle of rise/fall from a specified altitude (e.g. useful for 2D and 3D 360-degree views from a specific location) using metadata.
Find image(s), video(s), or data associated thereof for the user, in turn, selecting criteria of a search result at block 750-10 after block 750-32, wherein a user can continue to use previous search results to find subsequent search results (i.e. recursive search), for example one or more attributes (metadata) for a photo of one search result is selected for retrieving a new search result of photos having those same attributes, or find image(s) or video(s) in a search result and use attributes such as their location, date/time information, etc. to find related image(s) or video(s), and optionally with a specified range as described above to expand the search criteria.
Find image(s), video(s), or data associated thereof for imagery captured and containing a person or people using data 286 (operators fully supported, for example to specify Joe and Sally, but not Sam).
Find image(s), video(s), or data associated thereof for imagery captured and containing a person or people together with other specified terms described above for a complex query (at location specification with or without a range, during date/time information, etc.).
Find image(s), video(s), or data associated thereof for imagery captured and containing a person or people within a range of imagery captured at a location specification and containing the same or other person or people.
Find image(s), video(s), or data associated thereof for imagery captured containing a recognized object of data 288 and with optional additional criteria (e.g. images showing anyone wearing a similar jacket in Sweden or Holland).
Find any data described for image(s), video(s), metadata, or data associated thereof, which is maintained in ICW 104 or client data 306.
Automatically determine client or user context information defaulting one or more terms of the query, and suggesting querying at block 750-10 based on those context determinations.
Undo processing using data 570 is performed at block 772. Each block of WCS processing which creates, deletes, or alters data, can be un-done at block 772. Thus, such user actions of FIGS. 7A to 7E are recorded in data 772 to facilitate undo functionality. Any time a user action prevents building upon a pending rollback unit of work for undo functionality, records are moved from data 570 to 558 for beginning a new unit of work.

Company name and/or product name trademarks used herein belong to their respective companies.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

What is claimed is:

1. A data processing system implemented method for processing imagery data, comprising:
collecting information for a plurality of imagery objects from a plurality of sources in accordance with a collection configuration;
storing the information for facilitating searching of the information;
maintaining with the information a plurality of metadata instances for each particular imagery object of the plurality of imagery objects wherein each particular metadata instance of the plurality of metadata instances includes a particular metadata type and a particular confidence factor, the particular confidence factor for defining an accuracy in associating the particular metadata instance with the particular imagery object;
providing an alteration user interface for modifying the plurality of metadata instances including the particular metadata type and the particular confidence factor; and
providing a search user interface for accessing the information wherein the search is user interface presents search results by using the particular confidence factor for defining the accuracy in associating the particular metadata instance with the particular imagery object.

2. The method of claim 1 wherein the collection configuration is administrated by a plurality of users.

3. The method of claim 1 including transforming an imagery object from a first format to a second format after the collecting and prior to the storing.

4. The method of claim 1 including analyzing an imagery object and associating new metadata to the imagery object based on the analyzing the imagery object.

5. The method of claim 1 including invoking a plug-in application programming interface for associating new metadata to an imagery object.

6. The method of claim 1 including storing an imagery object to a source of the imagery object after transforming the imagery object or altering metadata associated with the imagery object.

7. The method of claim 1 wherein the search user interface uses contextual search criteria determined for a data processing system requesting the search user interface, the contextual search criteria for qualifying a search result without requiring a user to specify the contextual search criteria.

8. The method of claim 1 wherein the search user interface includes configuring a queued query for providing the search results upon data becoming available at a future time in the information, the queued query notifying a user upon the data becoming available at the future time.

9. The method of claim 1 wherein the alteration user interface includes processing for transforming an imagery object from a first format to a second format.

10. The method of claim 1 wherein the alteration user interface includes processing for invoking a plug-in application programming interface for analyzing, removing, altering, or adding imagery object metadata.

11. The method of claim 1 wherein each particular metadata instance of the plurality of metadata instances includes a particular metadata category.

12. The method of claim 1 including accepting from a first user an alteration in the information, the alteration for being approved by a higher level user.

13. The method of claim 1 including accepting from a first user an alteration in the information, the alteration for being promoted by a higher level user.

14. The method of claim 1 wherein the search user interface includes searching for panoramic imagery data using reference imagery data.

15. The method of claim 1 including sending a link to a recipient user which causes search processing for producing a search result upon selection by the recipient user.

16. The method of claim 1 including plug-in processing for performing a geocoded translation from a first location format to a second location format.

17. The method of claim 1 including plug-in processing for facial recognition or object recognition within the imagery objects.

18. The method of claim 1 including a plurality of users contributing metadata to the information for the facilitating searching of the information.

19. A program product including instructions configured to cause a data processing system to perform operations including:
collecting information for a plurality of imagery objects from a plurality of sources in accordance with a collection configuration;
storing the information for facilitating searching of the information;
maintaining with the information a plurality of metadata instances for each particular imagery object of the plurality of imagery objects wherein each particular metadata instance of the plurality of metadata instances includes a particular metadata type and a particular confidence factor, the particular confidence factor for defining an accuracy in associating the particular metadata instance with the particular imagery object;
providing an alteration user interface for modifying the plurality of metadata instances including the particular metadata type and the particular confidence factor; and
providing a search user interface for accessing the information wherein the search user interface presents search results by using the particular confidence factor for defining the accuracy in associating the particular metadata instance with the particular imagery object.

20. An imagery data processing system, comprising:
one or more processors;
a user interface; and
memory coupled to the one or more processors and storing instructions which, when executed by the one or more processors, causes the one or more processors to perform operations comprising:
collecting information for a plurality of imagery objects from a plurality of sources in accordance with a collection configuration;
storing the information for facilitating searching of the information;
maintaining with the information a plurality of metadata instances for each particular imagery object of the plurality of imagery objects wherein each particular metadata instance of the plurality of metadata instances includes a particular metadata type and a particular confidence factor, the particular confidence factor for defining an accuracy in associating the particular metadata instance with the particular imagery object;
providing an alteration user interface for modifying the plurality of metadata is instances including the particular metadata type and the particular confidence factor; and
providing a search user interface for accessing the information wherein the search user interface presents search results by using the particular confidence factor for defining the accuracy in associating the particular metadata instance with the particular imagery object.
